(19) United States
(12) Patent Application Publication
(10) Pub. No.: US 2023/0015171 A1
(43) Pub. Date: Jan. 19, 2023

(54) COMPOSITIONS, METHODS, AND SYSTEMS FOR MICROWAVE ENHANCED CARBON DIOXIDE-DEHYDROAROMATIZATION OVER MULTIFUNCTIONAL CATALYSTS

(71) Applicant: West Virginia University Board of Governors on Behalf of West Virginia University, Morgantown, WV (US)

(72) Inventors: Jianli HU, Morgantown, WV (US); Yuxin WANG, Morgantown, WV (US); Xiaoyan WANG, Morgantown, WV (US)

(21) Appl. No.: 17/858,018

(22) Filed: Jul. 5, 2022

Related U.S. Application Data
(63) Continuation of application No. 63/217,903, filed on Jul. 2, 2021.

(51) Int. Cl. B01J 23/58; B01J 23/10; B01J 35/00; B01J 35/02; C01B 3/40; C10G 1/10

(52) U.S. Cl. CPC B01J 23/58; B01J 23/10; B01J 35/0013; B01J 35/026; B01J 35/006; C01B 3/40; C10G 1/10; C01B 2203/0238; C01B 2203/1241; C01B 2203/1252; C01B 2203/1064; C01B 2203/1082; C10G 2400/30; C10G 2400/20; C10G 2300/1003

(57) ABSTRACT

In one aspect, the disclosure relates to multi-functional catalysts for use in carbon dioxide-assisted dehydroaromatization (CO₂-DHA) processes utilizing a microwave reactor. The disclosed multifunctional catalysts inhibit coke production, thereby solving a long-standing problem of rapid deactivation and regeneration issues. Moreover, the disclosed multifunctional catalysts, when used in the disclosed processes, provide for a reduced reaction temperature and improved BTX aromatic selectivity versus conventional process. The disclosed multifunctional catalysts for the aromatization of natural gas provide a more cost effective and energy efficient processes than existing conventional methods. Accordingly, the disclosed technology can significantly improve process economics for natural gas conversion and BTX aromatics production and yield a higher percent of product while limiting side reactions. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/217,903, filed on Jul. 2, 2021, which is incorporated herein by reference in its entirety.

### BACKGROUND

Natural gas is a promising feedstock for production of value-added transportable fuels and chemicals because of its low cost and unprecedented supply, e.g., in 2019, global natural gas production was 4 trillion cubic meters, with the U.S. being the global leader producing 921 billion cubic meters (BCM).

H₂ is considered an ideal fuel in future energy mixes because its combustion product is H₂O. Natural gas is considered as a good source of H₂ due to high hydrogen concentration, especially for methane and ethane [Refs. 3-4]. The most important industrial route of H₂ production is based on catalytic steam reforming of natural gas, consisting of natural gas treatment with water steam at high pressure (15-40 bar) and high temperature (650-950° C.) over catalysts [Ref. 5]. Unfortunately, this process requires a large amount of heat input in order to raise the temperature of the natural gas-steam mixture to a point where a large degree of molecular dissociation occurs. Natural gas thermal decomposition has been proposed as a viable alternative to the steam reforming since it produces almost pure H₂. A pioneered process for producing H₂ by thermal decomposition of natural gas is the HYPRO process, which was demonstrated by UOP in McCook [Ref. 6]. These conventional process have multiple constraints limiting their widespread adoption and economical use: (1) high energy input with poor energy efficiency; (2) catalyst deactivation and regeneration; and (3) low value byproducts, leading to low economical.

Although H₂ is a desired product from utilization of natural gas as a feedstock, from an economic standpoint of view, the challenge of converting natural gas to H₂ is to produce high value byproducts that can offset the capital and feedstock costs. However, if the production of high value BTX (benzene, toluene, and three xylene) aromatics as main byproduct could be realized in an efficient and cost-effective manner, then the use of natural gas may become very attractive. The dehydroaromatization (DHA) is considered a possible technology for H₂ production from natural gas. However, conventional DHA is catalyzed by metal doped catalysts supported on shape-selective zeolites and suffers from severe challenges including: (1) high endothermicity, leading to high energy consumption; (2) coke formation, leading to catalyst rapid deactivation; and (3) low conversion, leading to low H₂ production [Refs 7-8[. The high energy consumption and severe catalyst deactivation involved in the process have limited its use in commercial settings.

Similar limitations are associated with conventional catalytic oxidative DHA processes, e. g. carbon dioxide-assisted DHA (CO₂-DHA). However, in these conventional CO₂-DHA processes, e.g., those that use a zeolite-supported catalyst, the presence of CO₂ does not result in improved conversion and selectivity, and conventional zeolite-supported metal catalysts still suffer from rapid deactivation and reduced CO₂ conversion activity. These are major hurdles in commercializing natural gas-based aromatization technologies using conventional processes and catalysts.

Accordingly, despite advances in the improving the efficiency and utility of CO₂-DHA processes, there remains a need for processes and catalysts that can efficiently and cost-effectively convert natural gas and CO₂ while inhibiting high coke formation. These needs and other needs are satisfied by the present disclosure.

### SUMMARY

In accordance with the purpose(s) of the disclosure, as embodied and broadly described herein, the disclosure, in one aspect, relates to multi-functional catalysts for use in carbon dioxide-assisted dehydroaromatization (CO₂-DHA) processes utilizing a microwave reactor. The disclosed multifunctional catalysts inhibit coke production, thereby solving a long-standing problem of rapid deactivation and regeneration issues. Moreover, the disclosed multifunctional catalysts, when used in the disclosed processes, provide for a reduced reaction temperature and improved BTX aromatic selectivity versus conventional process. The disclosed multifunctional catalysts for the aromatization of natural gas provide a more cost effective and energy efficient processes than existing conventional methods. Accordingly, the disclosed technology can significantly improve process economics for natural gas conversion and BTX aromatic production and yield a higher percent of product while limiting side reactions.

Disclosed herein are multifunctionals catalyst comprising: a catalyst support comprising CeO₂, Cr₂O₃, La₂O₃, Y₂O₃, or combinations thereof; a catalyst metal comprising at least one metal selected from Groups 6-11; and optionally a catalyst promoter comprising at least one metal selected from Group 1, and Group 2; wherein the catalyst is capable of interacting with microwave energy in the frequency range of 300 MHz to 50 GHz; wherein the catalyst metal is present in an amount from about 0.1 wt % to about 20 wt %; wherein the catalyst promoter, when present, is in an amount from about 0.1 wt % to about 20 wt %; and wherein the wt % is based on the total weight of the catalyst support, the catalyst metal, and the catalyst promoter, when present.

Also disclosed herein are processes for carbon-dioxide assisted dehydroaromatization, the process comprising: providing a reaction chamber within a reactor with a disclosed multifunctional catalyst; heating the multifunctional catalyst using microwave energy with microwave energy in the frequency range of 300 MHz to 50 GHz; conveying a flow of a reactant gas mixtures into the reaction chamber via an entry port; wherein the reaction chamber pressurizes the reaction chamber to a pressure from about 0.9 atm to about 70 atm; contacting the reactant mixture with the multifunctional catalyst; and reacting the reactant gas mixture in contact with the heterogenous catalyst, thereby providing a product mixture; wherein the multifunctional catalyst has a multifunctional catalyst temperature of from about 100° C. to about 800° C.; wherein the reactant mixture comprises a hydrocarbon and optionally carbon dioxide; and wherein the product mixture comprises hydrogen and at least one aromatic or alkene.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a representative schematic representation of a disclosed microwave catalytic CO₂-DHA process utilizing a disclosed multifunctional catalyst for production of H₂ and value-added chemicals from natural gas contrasted to conventional CO₂-DHA processes over zeolite-supported metal catalysts.

FIG. 2 shows prior art data (see Ref. 25) for conversion of ethane using a conventional zeolite catalyst (Mo—Fe/ZSM-5 comprising 4 wt % Mo, 0.5 wt % Fe with ZSM-5 support) carried out in a microwave reactor (indicated as microwave energy-375 in the figure) versus a thermally heated reactor (indicated as FB-660 in the figure). The reactor operating temperature was 375° C. for the microwave reactor and 660° C. for the thermally heated reactor.

FIGS. 3A-3C shows representative data for the effect of temperature and carbon dioxide on the several aspects of a disclosed CO₂-DHA process utilizing a disclosed multifunctional catalyst in a thermally heated reactor. The catalyst composition is described in the Examples herein below. FIG. 3A shows the effect of varying temperature on the percent conversion of ethane in a disclosed CO₂-DHA process utilizing a disclosed multifunctional catalyst in the presence and absence of carbon dioxide as indicated in the figure in a thermally heated reactor. FIG. 3B shows the effect of varying temperature on the hydrogen production rate in a disclosed CO₂-DHA process utilizing a disclosed multifunctional catalyst in the presence and absence of carbon dioxide as indicated in the figure in a thermally heated reactor. FIG. 3C shows the effect of varying temperature on the BTX selectivity in a disclosed CO₂-DHA process utilizing a disclosed multifunctional catalyst in the presence and absence of carbon dioxide as indicated in the figure in a thermally heated reactor. The multifunctional catalyst used to obtain the data shown in FIGS. 3A-3C was CsRu/CeO₂ as described in the Examples.

FIGS. 4A-4C shows representative data for the effect of temperature and carbon dioxide on the several aspects of a disclosed microwave catalytic CO₂-DHA process utilizing a disclosed multifunctional catalyst in a microwave heated reactor. The catalyst is that as used in FIGS. 3A-3C. FIG. 4A shows the effect of varying temperature on the percent conversion of ethane in a disclosed microwave catalytic CO₂-DHA process utilizing a disclosed multifunctional catalyst in the presence and absence of carbon dioxide as indicated in the figure in a microwave heated reactor. FIG. 4B shows the effect of varying temperature on the hydrogen production rate in a disclosed microwave catalytic CO₂-DHA process utilizing a disclosed multifunctional catalyst in the presence and absence of carbon dioxide as indicated in the figure in a microwave heated reactor. FIG. 4C shows the effect of varying temperature on the BTX selectivity in a disclosed microwave catalytic CO₂-DHA process utilizing a disclosed multifunctional catalyst in the presence and absence of carbon dioxide as indicated in the figure in a microwave heated reactor. The multifunctional catalyst used to obtain the data shown in FIGS. 4A-4C was CsRu/CeO₂ as described in the Examples.

FIG. 5 shows representative data for conversion of ethane using a disclosed multifunctional catalyst in a microwave heated reactor versus a thermally heated reactor as indicated. The data show that using a disclosed multifunctional catalyst that utilizing a disclosed microwave catalytic process, the conversion of ethance can be carried out at a temperature 250° C. lower a thermally heated reactor using the same catalyst. The catalyst is that as used in FIGS. 3A-3C.

FIGS. 6A-6C show representative data characterizing a disclosed multifunctional catalyst, a disclosed CsRu/CeO₂ catalyst. FIG. 6A shows representative x-ray diffraction data of a disclosed CsRu/CeO₂ catalyst. The data show that the Ru diffraction peaks are hard to observed over CsRu/CeO₂ catalysts, suggesting the presence of small particle size of Ru over CeO₂ supported catalysts. FIG. 6B shows a representative transmission electron micrograph image of a disclosed CsRu/CeO₂ catalyst. FIG. 6C shows a representative high-resolution transmission electron micrograph image of a disclosed CsRu/CeO₂ catalyst. The images in FIGS. 6B-6C show that Ru particles are not visible on CeO₂ support, even with high-resolution TEM (HRTEM). The image data suggests that formation of the active phase results in highly dispersed Ru nanoparticles, which is likely associated with the improved catalytic activity of the disclosed multifunctional catalysts.

FIGS. 7A-7D show representative data obtained using the disclosed catalysts in disclosed non-oxidative ethane dehydrogenation methods. FIG. 7A shows ethane conversion and ethylene yield for the catalysts as indicated therein. FIG. 7B show ethylene selectivity data. FIG. 7C shows BTX select data. FIG. 7D shows distribution data for light olefins.

FIGS. 8A-8D show representative data obtained using a disclosed catalyst, CsRu/CeO₂, in disclosed non-oxidative ethane dehydrogenation methods. FIG. 8A shows ethane conversion data and yield of light olefins and BTX. FIG. 8B shows selectivity data for light olefins and BTX. FIG. 8C show data for distribution of light olefins. FIG. 8D shows carbon balance data.

FIGS. 9A-9D show representative data obtained using a disclosed catalysts in disclosed oxidative ethane dehydrogenation methods. FIG. 9A shows ethane conversion data and yield of light olefins over Ru/CeO₂ and CsRu/CeO₂ catalysts. FIG. 9B shows data comparing ethane conversion and light olefins yield in disclosed EDH and ODH processes. FIG. 9C shows ethane conversion over CsRu/CeO₂ at different feeding rate. FIG. 9D shows data for light olefins distribution over CsRu/CeO₂.

FIGS. 10A-10D show representative ethane conversion data for disclosed oxidative ethane dehydrogenation processes carried out at different CO₂/O₂H₆ ratio and feed rates. FIG. 10A shows ethane conversion, light olefins yield and BTX yield over CsRu/CeO₂ with different CO₂ concentration (Reaction conditions in graph: GHSV: 4800 h⁻¹; ratios are: a. CO₂:C₂H₆:N₂ is 1:4:3; b. CO₂:C₂H₆:N₂ is 2:4:2; c. CO₂:C₂H₆:N₂ is 3:4:1). FIG. 10B shows data for CO₂ conversion and CO productivity over CsRu/CeO₂ at various temperatures (Reaction condition: GHSV: 3600 h⁻¹; ratio N₂:C₂H₆:CO₂ is 1:1:1). FIG. 10C shows data for selectivity of light olefins and BTX over CsRu/CeO₂ at different feed rate as indicated. FIG. 10D shows data for ethane conversion and yield of light olefins and BTX over CsRu/CeO₂ (Reaction condition in C and D: a. 1800 h⁻¹; b. 3600 h⁻¹; c. 7200 h⁻¹; ratio N₂:C₂H₆:CO₂ is 1:1:1).

FIG. 11 shows representative data for stability of CsRu/CeO₂ in ODH (Reaction condition: N₂:10 ml/min, C₂H₆:10 ml/min, CO₂:10 ml/min, 750° C.).

FIGS. 12A-12D show representative data a disclosed catalyst. CsRu/CeO₂, in disclosed non-oxidative ethane dehydrogenation methods. FIG. 12A shows ethane conversion data. FIG. 12B shows light olefin selectivity data. FIG. 12C shows light olefin yield data. FIG. 12D shows data for BTX selectivity and yield. Reaction condition: 50% of C₂H₆ and 50% of N₂ GHSV: 1200 h⁻¹, 2400 h⁻¹, 4800 h⁻¹.

FIGS. 13A-13D show representative data a disclosed catalyst. CsRu/CeO₂, in disclosed oxidative ethane dehydrogenation methods. FIG. 13A shows ethane conversion data. FIG. 13B shows light olefin selectivity data. FIG. 13C shows light olefin yield data. FIG. 13D shows data for BTX selectivity and yield. Reaction condition: GHSV: 1800 h⁻¹, 3600 h⁻¹, 7200 h⁻¹; ratio N₂:C₂H₆:CO₂ is 1:1:1.

FIGS. 14A-14B show representative data comparing the performance of CsRu/CeO₂ in non-oxidative ethane dehydrogrenation methods (see FIG. 14A) and oxidative ethane dehydrogenation methods (see FIG. 14B).

FIG. 15 shows representative carbon and oxygen balance data in a disclosed oxidative ethane dehydrogenation method. Reaction condition: GHSV: 1800 h⁻¹, 3600 h⁻¹, 7200 h⁻¹; ratio N₂:O₂H₆:CO₂ is 1:1:1.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a metal oxide,” “an inert gas,” or “a catalyst,” includes, but is not limited to, two or more such metal oxides, inert gases, or catalysts, and the like.

Moreover, reference to “a” chemical compound refers one or more molecules of the chemical compound, rather than being limited to a single molecule of the chemical compound. Furthermore, the one or more molecules may or may not be identical, so long as they fall under the category of the chemical compound. Thus, for example, “a” heterogeneous catalyst is interpreted to include one or more heterogeneous catalyst molecules that may or may not be identical (e.g., different compositions of a heterogeneous catalyst within the scope of the present disclosure).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a catalyst refers to an amount that is sufficient to achieve the desired improvement in the property modulated by the formulation component, e.g. achieving the desired level of modulus. Thus, for example, the specific level in terms of wt % of specific components in a heterogeneous catalyst composition required as an effective amount will depend upon a variety of factors including the amount and type of catalyst; composition of reactant gas mixture; amount, frequency and wattage of microwave energy that will be used during product; and production requirements in the use of the heterogeneous catalyst in preparing ammonia by the disclosed methods.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt %,” and “wt %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

As used herein the terms “volume percent,” “vol %,” and “vol. %,” which can be used interchangeably, indicate the percent by volume of a given gas based on the total volume at a given temperature and pressure, unless otherwise specified. That is, unless otherwise specified, all vol % values are based on the total volume of the composition. It should be understood that the sum of vol % values for all components in a disclosed composition or formulation are equal to 100.

It is to be understood that when “Ba” (i.e., barium) is disclosed that it encompasses all valence states of Ba as appropriate to the chemical context. This is to be understood similarly for any disclosure of a metal, e.g., Ce or another metal, in the disclosed catalysts.

Abbreviations used herein are: “ODH” refers to oxidative ethane dehydrogenation; “EDH” refers to non-oxidative ethane dehydrogenation; and “BTX” refers to aromatic compounds comprising benzene, toluene, and xylene.

Compounds are described using standard nomenclature. Unless defined otherwise, technical and scientific terms used herein have the same meaning as is commonly understood by one of skill in the art to which this disclosure belongs. For example, reference to Group 1, Group 2, and other atoms are in reference to IUPAC nomenclature as it applies to the periodic table. In particular, the group nomenclature used herein is that this is in accordance with that put forth in the IUPAC proposal was first circulated in 1985 for public comments (Pure Appl. Chem. IUPAC. 60 (3): 431-436. doi:10.1351/pac198860030431), and was later included as part of the 1990 edition of the Nomenclature of Inorganic Chemistry (Nomenclature of Inorganic Chemistry: Recommendations 1990. Blackwell Science, 1990. ISBN 0-632-02494-1).

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### B. Introduction

The present disclosure relates to multi-functional catalysts for use in carbon dioxide-assisted dehydroaromatization (CO₂-DHA) processes utilizing a microwave reactor. The disclosed processes efficiently yield hydrogen and value-added hydrocarbons. The disclosed multifunctional catalysts inhibit coke production, thereby solving a long-standing problem of rapid deactivation and regeneration issues. Moreover, the disclosed multifunctional catalysts, when used in the disclosed processes, provide for a reduced reaction temperature and improved BTX aromatic selectivity versus conventional process. The disclosed multifunctional catalysts for the aromatization of natural gas provide a more cost effective and energy efficient processes than existing conventional methods. Accordingly, the disclosed technology can significantly improve process economics for natural gas conversion to produce hydrogen and BTX aromatics with a higher percent yield while limiting side reactions compared to conventional prior art methods.

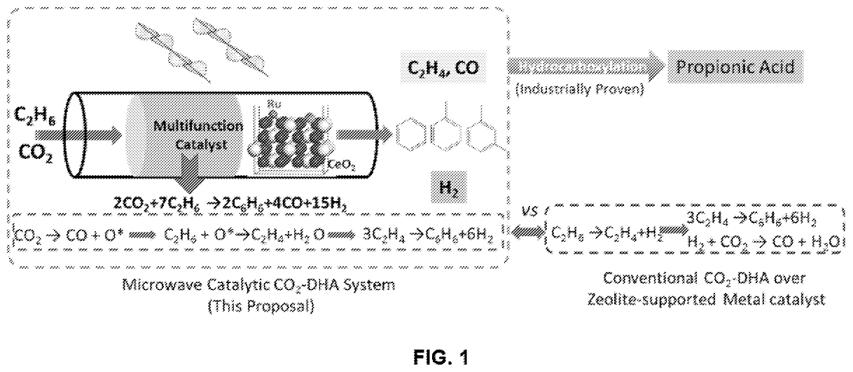

In various aspects, the present disclosure relates to multifunctional catalysts and processes utilizing the disclosed multifunctional catalysts. The disclosed processes provide a comprehensive process for the sustainable and cost-effective production of H₂ from natural gas resources. In a further aspect, aspects of the disclosed process are shown schematically in FIG. 1 with comparison to a conventional process utilizing a zeolite-supported catalyst with thermal heating. In a still further aspect, the processes of the present disclosure provide relate to CO₂ assisted ethane dehydroaromatization (CO₂-DHA) under microwave (MW) irradiation over the disclosed multifunctional catalysts. The disclosed processes can provide H₂ production, as well as high-value chemicals (aromatics, ethylene, and CO, etc.). The disclosed processes significantly improve the efficiency and economics of carbon dioxide-assisted dehydroaromatization (CO₂-DHA) processes compared to conventional processes. The products obtained using the disclosed processes, e.g., CO and ethylene can subsequently convert into value-added propionic acid via conventional hydrocarboxylation processes.

Conventional CO₂-assisted DHA, as illustrated in FIG. 1, is a process catalyzed by zeolite supported metal or metal carbides and suffers from severe challenges including low activity for ethane/CO₂ conversion resulting in low H₂ production, rapid catalyst deactivation, and high reaction temperature. The disclosed processes address the challenges inherent in conventional CO₂-DHA methods to achieve the low-cost H₂ production while producing high value hydrocarbons such as BTX aromatics. In particular, the disclosed processes are believed to overcome the challenges of conventional processes by integration of catalyst design, synthesis, and microwave reaction chemistry to activate ethane and CO₂ simultaneously for H₂ production. The disclosed multifunctional catalysts have a significant ability to absorb/utilize microwave energy to achieve high single pass conversion with high selectivity to H₂. Unlike conventional zeolite supported metal catalysts, the disclosed multifunctional catalysts comprise a reducible oxide supported catalyst (e.g., one or more of CeO₂, Cr₂O₃, La₂O₃, or Y₂O₃). The disclosed processes are the first disclosure of aromatization of alkanes without using zeolite. Moreover, the disclosed multifunctional catalysts possess high catalytic activity, and are also associated with coke inhibiting properties, thereby ensuring high catalyst stability and process robustness.

The disclosed multifunctional catalysts used in the disclosed processes provide significant improvement and advantage over conventional CO₂-DHA processes. In various aspects, the disclosed multifunctional catalysts, e.g., a disclosed CsRu/CeO₂ catalyst, used in the disclosed microwave catalytic CO₂-DHA processes provide single pass ethane and CO₂ conversation efficiencies of 80% and 90%, respectively. In a still further aspect, the disclosed multifunctional catalysts, e.g., a disclosed CsRu/CeO₂ catalyst, used in the disclosed microwave catalytic CO₂-DHA processes a significantly improved selectivity to H₂ and aromatics. In yet a further aspect, compared with conventional thermal heating, microwave catalysis significantly reduced the reaction temperature to reach the same ethane conversion level. The reduced temperatures that can be used in the disclosed microwave catalytic CO₂-DHA processes comprising the disclosed multifunctional catalysts, e.g., a disclosed CsRu/CeO₂ catalyst, provide for improved long-term stability of the catalysts in use, thereby avoiding avoid frequent regeneration and further improving the process economics for H₂ production.

Without wishing to be bound by a particular theory, it is believed these improvements are associated with selective heating of the active sites. For example, as shown in FIG. 1, an aspect of the disclosed processes comprising the disclosed multifunctional catalysts is CO₂ activation to form reactive oxygen species (*O) that can induce activation of ethane:

CO₂→CO+O*,C₂H₆+O*→O₂H₄+H₂O.

The ethylene that is formed in the foregoing reaction can subsequently aromatize and release more H₂, as shown in the following reaction:

3C₂H₄→C₆H₆+6H₂.

Major side reactions include dry reforming reaction (DRE):

O₂H₆+2CO₂=4CO+3H₂;

and water-gas shift reaction (WGSR):

CO+H₂O [symbol] CO₂+H₂;

each of which will releases more H₂. The disclosed microwave catalytic CO₂-DHA processes comprising disclosed multifunctional catalysts are believed to simultaneously activate CO₂, activate ethane, and catalyze subsequent aromatization, thereby providing a low temperature process to activating ethane and CO₂.

The disclosed microwave catalytic CO₂-DHA processes comprising disclosed multifunctional catalysts approach addressing all the requirements of an ideal CO₂-DHA process, namely that the catalyst is capable of the following: 1) activating CO₂ to produce surface oxygen; 2) activating ethane to produce ethylene and H₂; and 3) aromatizing ethylene to produce aromatics and release more H₂. Moreover, the disclosed microwave catalytic CO₂-DHA processes comprising disclosed multifunctional catalysts promote a water-gas shift reaction for the H₂ production direction providing further favorability for the disclosed processes. Controlling the subtle balance of activity of these reactions has been a key challenge that is addressed by the disclosed processes.

The activation of CO₂ is believed to occur on the support or at the interface between the active metal and the oxide support (i.e., zeolite support), and the reducibility of the catalyst support is considered as the key factor for activating CO₂ [Ref. 14]. In contrast to other support materials such as zeolite, CeO₂ is a highly reducible oxide, which can be readily reduced to Ce³⁺ thermally or chemically [Refs. 15-16]. A reduced oxide has a strong tendency to react with CO₂, even causing direct C═O bond scission. A first-principles study has been theoretically proven noble metal (Ru, Pt, and Rh) had high capability to activate C—C bonds of alkane to produce H₂ and CO with the high resistant to carbon formation [Refs. 17-18]. Meanwhile, the CeO₂ and Ru demonstrated the activity for dehydrogenation of ethane to form ethylene [Refs. 19-20]. Noble metals supported on a reducible oxide (e.g., Pt/CeO₂) are a WGSR catalyst with high active for H₂ production [Ref. 21].

In contrast, conventional CO₂-DHA processes (as shown for contrast in FIG. 1) utilizing zeolite-supported catalysts, is believed to occur through a Mars-van-Krevelen-type mechanism [Ref. 12], in which ethane is first dehydrogenated into ethylene and H₂, then CO₂ is reduced by H₂ to form CO and H₂O through the reverse water-gas shift reaction [Ref. 13]. The presence of H₂O under reaction conditions causes dealumination of zeolite resulting the catalyst deactivation. Moreover, the desired product H₂ is consumed by CO₂, reducing the overall H₂ yield. In conventional CO₂-DHA processes, due to the absence of active sites for CO₂ activation to form *O over zeolite supported catalyst, ethane activation over the zeolite catalyst is difficult. Thus, in these conventional processes, a high temperature (>700° C.) to activate ethane and CO₂ molecules, which are relatively stable molecules, and accordingly result in high energy consumption as well as catalyst deactivation. In conventional DHA processes, it is believed that the strong Brønsted acid sites and pore structure of zeolite are parameters for aromatization. As previously noted, currently nearly all the conventional aromatization catalysts use zeolite as support. However, the strong acidity and small pore size in zeolite supports are believed to contribute significantly to coking which results in the rapid deactivation.

The disclosed microwave catalytic CO₂-DHA process integrate microwave reaction chemistry with a disclosed multifunctional catalyst and provides several distinct advantages compared to conventional processes and/or conventional catalysts for CO₂-DHA processes, in particular: (1) high activity ethane and CO₂ single-pass conversion and high efficiency H₂ production; (2) long-term catalyst stability, e.g., the Examples show that the disclosed multifunctional catalysts maintain high activity without deactivation over 700 min time-on-stream with multiple shut-down/start-up interruption; (3) high value byproducts are produced, e.g., value-added BTX aromatics, ethylene, and CO as byproducts; and (4) energy saving associated with the reduced temperatures that can be used with microwave chemistry using disclosed multifunctional catalysts, e.g., temperatures can be reduced by about 250° C. to achieve a similar ethane conversion compared to thermal heated reactors using the same catalyst.

In endothermic reactions, the heat required can be supplied from conventional heat sources or recovered waste heat, such as heat from catalyst regeneration (residual coke burn). In the disclosed microwave catalytic CO₂-DHA processes, the energy usage compared to conventional thermal catalytic processes is decreased as shown in energy usage calculations of Table 1. The disclosed processes have much higher “net energy gain” than traditional thermal catalytic methods, at least in part because microwave energy is selectively delivered to the catalyst sites which is more efficient than conventional conductive/convective heating.

TABLE 1

| | Disclosed Processes | Conventional Processes |
|---|---|---|
| Reaction | 2CO₂ + 7C₂H₆→2C₆H₆ + | CH₄ + 2H₂O → 4H₂ + |
| parameter | 4CO + 15H₂ | CO₂ |
| Heat required | 69 kJ/mol H₂ | 165 kJ/mol H₂ |
| for reaction | | |
| Microwave | 5 kJ/ mol H₂ | N/A |
| energy input | | |
| Total process | 74 kJ/mol H₂ | 165 kJ/mol H₂ |
| utility energy | | |
| input | | |
| Output | 285 kJ/mol H₂ | 285 kJ/mol H₂ |
| | (not counting on energy | |
| | from aromatics) | |
| Net energy gain | 211 kJ/mol H₂ | 120 kJ/mol H₂ |

### C. Catalyst Compositions

In one aspect, the present disclosure relates multifunctional catalysts comprising: a catalyst support comprising CeO₂, Cr₂O₃, La₂O₃, Y₂O₃, or combinations thereof; a catalyst metal comprising at least one metal selected from Groups 6-11; and optionally a catalyst promoter comprising at least one metal selected from Group 1, and Group 2; wherein the catalyst is capable of interacting with microwave energy in the frequency range of 300 MHz to 50 GHz; wherein the catalyst metal is present in an amount from about 0.1 wt % to about 20 wt %; wherein the catalyst promoter, when present, is in an amount from about 0.1 wt % to about 20 wt %; and wherein the wt % is based on the total weight of the catalyst support, the catalyst metal, and the catalyst promoter, when present.

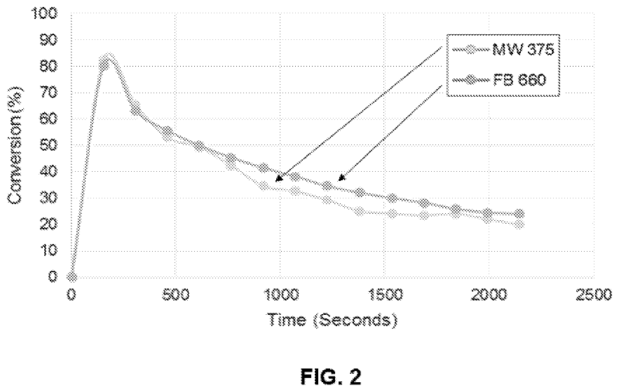

The disclosed multifunctional catalysts comprise metals with dielectric properties that allow them to absorb microwave energy. Coupling of the microwave field with certain features of the catalyst, like dipoles on the surface, is believed to affect charge distributions at specific sites which enables the electromagnetic energy to impact electronic interactions in the reaction catalyzed. Moreover, coupling of the microwave field with certain features of the catalyst, like dipoles on the surface, is believed to affect the extent of dipole formation and/or charge transfers which can lead to increases in conversion and selectivity. Microwave reactors can be operated at lower temperature (375° C. bulk catalyst temperature) to reach the same conversion level as achieved in a thermally heated reactor (660° C.), as shown in FIG. 2 [Ref. 25] using a catalyst comprising a ZSM-5 support (4 wt % Mo-0.5 wt % Fe/ZSM-5), with an aromatics formation rate that was two order of magnitude higher under microwave heating than in a conventional thermally heated fixed-bed reactor [Ref. 26] using similar catalysts comprising ZSM-5 supports.

In a further aspect, the present disclosure relates multifunctional catalysts comprising: a catalyst support comprising CeO₂; a catalyst metal comprising at least one metal selected from Groups 6-11; and optionally a catalyst promoter comprising at least one metal selected from Group 1, and Group 2; wherein the catalyst is capable of interacting with microwave energy in the frequency range of 300 MHz to 50 GHz; wherein the catalyst metal is present in an amount from about 0.1 wt % to about 20 wt %; wherein the catalyst promoter, when present, is in an amount from about 0.1 wt % to about 20 wt %; and wherein the wt % is based on the total weight of the catalyst support, the catalyst metal, and the catalyst promoter, when present.

In a further aspect, the present disclosure relates multifunctional catalysts comprising: a catalyst support comprising Cr₂O₃; a catalyst metal comprising at least one metal selected from Groups 6-11; and optionally a catalyst promoter comprising at least one metal selected from Group 1, and Group 2; wherein the catalyst is capable of interacting with microwave energy in the frequency range of 300 MHz to 50 GHz; wherein the catalyst metal is present in an amount from about 0.1 wt % to about 20 wt %; wherein the catalyst promoter, when present, is in an amount from about 0.1 wt % to about 20 wt %; and wherein the wt % is based on the total weight of the catalyst support, the catalyst metal, and the catalyst promoter, when present.

In a further aspect, the present disclosure relates multifunctional catalysts comprising: a catalyst support comprising La₂O₃; a catalyst metal comprising at least one metal selected from Groups 6-11; and optionally a catalyst promoter comprising at least one metal selected from Group 1, and Group 2; wherein the catalyst is capable of interacting with microwave energy in the frequency range of 300 MHz to 50 GHz; wherein the catalyst metal is present in an amount from about 0.1 wt % to about 20 wt %; wherein the catalyst promoter, when present, is in an amount from about 0.1 wt % to about 20 wt %; and wherein the wt % is based on the total weight of the catalyst support, the catalyst metal, and the catalyst promoter, when present.

In a further aspect, the present disclosure relates multifunctional catalysts comprising: a catalyst support comprising Y₂O₃; a catalyst metal comprising at least one metal selected from Groups 6-11; and optionally a catalyst promoter comprising at least one metal selected from Group 1, and Group 2; wherein the catalyst is capable of interacting with microwave energy in the frequency range of 300 MHz to 50 GHz; wherein the catalyst metal is present in an amount from about 0.1 wt % to about 20 wt %; wherein the catalyst promoter, when present, is in an amount from about 0.1 wt % to about 20 wt %; and wherein the wt % is based on the total weight of the catalyst support, the catalyst metal, and the catalyst promoter, when present.

In various aspects, the disclosed multifunctional catalyst comprises a promoter. Without wishing to be bound by a particular theory, it is believe that one or more promoter in combination with a support, can alter the electronic and geometric structure of the catalyst metal. In a further aspect,

### D. Processes for Preparing the Catalyst Compositions

In various aspects, disclosed are processes for synthesizing a disclosed multifunctional catalyst, the process comprising: forming a metal compound solution comprising a solvent and a metal compound; forming a mixture of the metal compound solution and a metal oxide; wherein the metal compound is present in amount corresponding to about 0.05 wt % to about 20 wt % based on the total weight of the metal oxide powder and the metal compound; wherein the metal compound is an organometallic compound or a metal salt comprising a metal selected from Group 7, Group 8, Group 9, Group 10, Group 11, or combinations thereof; wherein the metal oxide is present in an amount of about 80 wt % to about 99 wt % based on the total weight of the metal oxide and the metal compound; and, reacting the mixture at a temperature of about 5° C. to about 95° C. for a period of time from about 1 minute to about 72 hours; thereby forming the heterogeneous catalyst.

In a further aspect, disclosed are processes for synthesizing a disclosed multifunctional catalyst, the process comprising: forming a metal compound solution comprising a solvent and a metal compound; forming a mixture of the metal compound solution and a metal oxide; wherein the metal compound is present in amount corresponding to about 0.05 wt % to about 20 wt % based on the total weight of the metal oxide powder and the metal compound; wherein the metal compound is an organometallic compound or a metal salt comprising a metal selected from Group 7, Group 8, Group 9, Group 10, Group 11, or combinations thereof; wherein the metal oxide is present in an amount of about 60 wt % to about 99 wt % based on the total weight of the metal oxide and the metal compound; and, reacting the mixture at a temperature of about 5° C. to about 95° C. for a period of time from about 1 minute to about 72 hours; thereby forming the heterogeneous catalyst.

In a further aspect, disclosed are processes for synthesizing a disclosed multifunctional catalyst, the process comprising: forming a metal compound solution comprising a solvent and a metal compound; forming a mixture of the metal compound solution and a metal oxide; wherein the metal compound is present in amount corresponding to about 0.05 wt % to about 10 wt % based on the total weight of the metal oxide powder and the metal compound; wherein the metal compound is an organometallic compound or a metal salt comprising a metal selected from Group 7, Group 8, Group 9, Group 10, Group 11, or combinations thereof; wherein the metal oxide is present in an amount of about 60 wt % to about 99 wt % based on the total weight of the metal oxide and the metal compound; and, reacting the mixture at a temperature of about 5° C. to about 95° C. for a period of time from about 1 minute to about 72 hours; thereby forming the heterogeneous catalyst.

In various aspects, disclosed processes for synthesizing a disclosed multifunctional catalyst, the process comprising: forming a ruthenium compound solution comprising a ruthenium compound and a solvent; forming a mixture of the ruthenium compound solution and a metal oxide; wherein the ruthenium compound is present in amount corresponding to about 0.05 wt % to about 20 wt % based on the total weight of the metal oxide powder and the ruthenium; wherein the ruthenium compound is an organometallic compound or a metal cation derived from a metal salt; wherein the metal oxide is present in an amount of about 60 wt % to about 99 wt % based on the total weight of the metal oxide and the ruthenium compound; and, reacting the mixture at a temperature of about 5° C. to about 95° C. for a period of time from about 1 minute to about 72 hours; thereby forming the heterogeneous catalyst.

In various aspects, disclosed processes for synthesizing a disclosed multifunctional catalyst, the process comprising: forming a ruthenium compound solution comprising a ruthenium compound and a solvent; forming a mixture of the ruthenium compound solution and a metal oxide; wherein the ruthenium compound is present in amount corresponding to about 0.05 wt % to about 20 wt % based on the total weight of the metal oxide powder and the ruthenium; wherein the ruthenium compound is an organometallic compound or a metal cation derived from a metal salt; wherein the metal oxide is present in an amount of about 60 wt % to about 99 wt % based on the total weight of the metal oxide and the ruthenium compound; and, reacting the mixture at a temperature of about 5° C. to about 95° C. for a period of time from about 1 minute to about 72 hours; thereby forming the heterogeneous catalyst.

In various aspects, disclosed are processes for synthesizing a disclosed multifunctional catalyst, the process comprising: forming a ruthenium compound solution comprising a ruthenium compound and a solvent; forming a mixture of the ruthenium compound solution and a metal oxide; wherein the ruthenium compound is present in amount corresponding to about 0.05 wt % to about 10 wt % based on the total weight of the metal oxide powder and the ruthenium; wherein the ruthenium compound is an organometallic compound or a metal cation derived from a metal salt; wherein the metal oxide is present in an amount of about 60 wt % to about 99 wt % based on the total weight of the metal oxide and the ruthenium compound; and, reacting the mixture at a temperature of about 5° C. to about 95° C. for a period of time from about 1 minute to about 72 hours; thereby forming the heterogeneous catalyst.

In various aspects, any of the foregoing processes, the mixture can further comprise a promoter, e.g., a Group 1 and/or Group 2 promoter compound such as a Group 1 and/or Group 2 salt.

In various aspects, the disclosed multifunctional catalysts can be prepared by an incipient wetness impregnation method.

In various aspects, the disclosed multifunctional catalysts can be prepared by using spray application methods comprising spraying a solution of a catalyst metal salt onto a catalyst support.

In various aspects, the disclosed multifunctional catalysts can be prepared using chemical vapor deposition methods.

In various aspects, the disclosed multifunctional catalysts can be prepared using a metal nano particle material, wherein a catalyst metal is prepared using sol-gel techniques, followed by adhering the catalyst metal containing sol-gel onto the catalyst support, then calcining the material to fix the ruthenium metal onto the catalyst support.

In various aspects, drying is understood to include a state wherein the catalyst is essentially dry, but nevertheless comprises some amount of solvent, such as water. That is the material can be dry but have solvent molecules present in the catalyst such that there are hydroxyl (OH) groups and protons present on a surface of the catalyst.

### E. Processes for Carbon-Dioxide Assisted Dehydroaromatization

In various aspects, the present disclosure pertains to processes for carbon-dioxide assisted dehydroaromatization, the process comprising: providing a reaction chamber within a reactor with a disclosed multifunctional catalyst; heating the multifunctional catalyst using microwave energy with microwave energy in the frequency range of 300 MHz to 50 GHz; conveying a flow of a reactant gas mixtures into the reaction chamber via an entry port; wherein the reaction chamber pressurizes the reaction chamber to a pressure from about 0.9 atm to about 20 atm; contacting the reactant mixture with the multifunctional catalyst; and reacting the reactant gas mixture in contact with the heterogenous catalyst, thereby providing a product mixture; wherein the multifunctional catalyst has a multifunctional catalyst temperature of from about 100° C. to about 700° C.; wherein the reactant mixture comprises carbon dioxide and a hydrocarbon; and wherein the product mixture comprises hydrogen and at least one aromatic or alkene.

In various aspects, the disclosed process utilizes variable microwave energy and a catalyst to efficiently synthesize ammonia from a reactant gas mixture comprising hydrogen and nitrogen.

In various aspects, the disclosed process utilizes a reactor configuration is such that reactor tube passing through the waveguide (along the direction of H-Field wave propagation). In some aspects, such a reactor configuration can be associated with improved heating efficiency compared to the scenario where the process tube passes through the broad wall of the wave guide. In a further aspect, the microwave energy is variably tuned. even with a fixed frequency microwave energy.

In a further aspect, a reactor configuration comprising variable-frequency microwave (VFM) can allow extended reaction operating times. In a still further aspect, the VFM can vary the frequency from 5.85 to 6.65 GHz. In a yet further aspect, any single frequency from the VFM bandwidth can be used, or the entire bandwidth can be rapidly swept in a fraction of a second, thereby allowing tuned excitation at frequencies associated with specific peaks in the loss tangent of the dielectric spectrum.

In a further aspect, the microwave reactor is a high pressure microwave reactor.

In a further aspect, the microwave reactor is a multimode microwave reactor.

In a further aspect, the microwave reactor is a monomode progressive microwave reactor.

In a further aspect, the microwave reactor is a progressive wave design microwave reactor.

In a further aspect, the reactor chamber is a quartz tube reactor chamber where the quartz tube reactor chamber has a quartz tube portion and a metal tube portion that is connected to the quartz tube portion via a pyrex glass/metal transition connector.

In a further aspect, the microwave reactor and reactor chamber is shielded with a transparent thermoplastic or thermoset tube that provides safety from any possible explosion that takes place within the microwave reactor.

In a further aspect, the microwave reactor and reactor chamber reactant gas mixtures and product effluent are analyzed with a gas chromatograph.

In a further aspect the gas chromatograph is a micro gas chromatograph.

### F. REFERENCES

References are cited herein throughout using the format of reference number(s) enclosed by parentheses corresponding to one or more of the following numbered references. For example, citation of references numbers 1 and 2 immediately herein below would be indicated in the disclosure as [Ref. 1, 2] or [Ref. 1-2].
[1] https://www.statista.com/statistics/265331/natural-gas-production-in-the-us/
[2] Gao, J., Zheng, Y., Jehng, J. M., Tang, Y., Wachs, I. E., & Podkolzin, S. G. (2015). Identification of molybdenum oxide nanostructures on zeolites for natural gas conversion. Science, 348(6235), 686-690.
[3] Bai, Z., Chen, H., Li, W., & Li, B. (2006). Hydrogen production by methane decomposition over coal char. International journal of hydrogen energy, 31(7), 899-905.
[4] Lee, E. K., Lee, S. Y., Han, G. Y., Lee, B. K., Lee, T. J., Jun, J. H., & Yoon, K. J. (2004). Catalytic decomposition of methane over carbon blacks for CO₂-free hydrogen production. Carbon, 42(12-13), 2641-2648.
[5] Chiarello, G. L., Aguirre, M. H., & Selli, E. (2010). Hydrogen production by photocatalytic steam reforming of methanol on noble metal-modified TiO₂. Journal of Catalysis, 273(2), 182-190.
[6] UOP Process cleaves hydrogen from hydrocarbons. Chem. Eng., 69 (1962)
[7] Lunsford, J. H. (2000). Catalytic conversion of methane to more useful chemicals and fuels: a challenge for the 21st century. Catalysis today, 63(2-4), 165-174.
[8] Liu, B., Yang, Y., & Sayari, A. (2001). Non-oxidative dehydroaromatization of methane over Ga-promoted Mo/HZSM-5-based catalysts. Applied Catalysis A: General, 214(1), 95-102.
[9] Nakagawa, K., Kajita, C., Okumura, K., Ikenaga, N. O., Nishitani-Gamo, M., Ando, T., . . . & Suzuki, T. (2001). Role of carbon dioxide in the dehydrogenation of ethane over gallium-loaded catalysts. journal of Catalysis, 203(1), 87-93.
[10] Hansen, J., Sato, M., Ruedy, R., Lo, K., Lea, D. W., & Medina-Elizade, M. (2006). Global temperature change. Proceedings of the National Academy of Sciences, 103(39), 14288-14293.
[11] Gomez, E., Nie, X., Lee, J. H., Xie, Z., & Chen, J. G. (2019). Tandem reactions of CO₂ reduction and ethane aromatization. Journal of the American Chemical Society, 141(44), 17771-17782.
[12] Heracleous, E., & Lemonidou, A. A. (2006). Ni—Nb—O mixed oxides as highly active and selective catalysts for ethene production via ethane oxidative dehydrogenation. Part II: Mechanistic aspects and kinetic modeling. Journal of Catalysis, 237(1), 175-189.
[13] Mimura, N., Okamoto, M., Yamashita, H., Oyama, S. T., & Murata, K. (2006). Oxidative dehydrogenation of ethane over Cr/ZSM-5 catalysts using CO₂ as an oxidant. The Journal of Physical Chemistry B, 110(43), 21764-21770.
[14] Appel, L. G., Eon, J. G., & Schmal, M. (1998). The CO₂—CeO₂ interaction and its role in the CeO₂ reactivity. Catalysis letters, 56(4), 199-202.
[15] Stagg, S. M., Romeo, E., Padro, C., & Resasco, D. E. (1998). Effect of Promotion with Sn on Supported Pt catalysts for CO₂ Reforming of CH₄. Journal of catalysis, 178(1), 137-145.
[16] Park, J. B., Graciani, J., Evans, J., Stacchiola, D., Ma, S., Liu, P., . . . & Rodriguez, J. A. (2009). High catalytic activity of Au/CeOx/TiO₂ (110) controlled by the nature of the mixed-metal oxide at the nanometer level. Proceedings of the National Academy of Sciences, 106(13), 4975-4980.
[17] Pakhare, D., & Spivey, J. (2014). A review of dry (CO₂) reforming of methane over noble metal catalysts. Chemical Society Reviews, 43(22), 7813-7837.
[18] An, W., Zeng, X. C., & Turner, C. H. (2009). First-principles study of methane dehydrogenation on a bimetallic Cu/Ni (111) surface. The Journal of chemical physics, 131(17), 174702.
[19] Yan, B., Yao, S., Kattel, S., Wu, Q., Xie, Z., Gomez, E., . . . & Chen, J. G. (2018). Active sites for tandem reactions of CO₂ reduction and ethane dehydrogenation. Proceedings of the National Academy of Sciences, 115(33), 8278-8283.
[20] Fathi, M., Bjorgum, E., & Rokstad, O. A. (2001). Conversion of ethane to ethylene and synthesis gas with cerium oxide. Promoting effect of Pt, Rh and Ru. Catalysis letters, 72(1), 25-31.
[21] Carta, D., Montini, T., Casula, M. F., Monai, M., Bullita, S., Fornasiero, P., & Corrias, A. (2017). The water gas shift reaction over Pt—CeO₂ nanoparticles confined within mesoporous SBA-16. Journal of Materials Chemistry A, 5(37), 20024-20034.
[22] Kosinov, N., Coumans, F. J., Uslamin, E. A., Wijpkema, A. S., Mezari, B., & Hensen, E. J. (2017). Methane dehydroaromatization by Mo/HZSM-5: mono- or bifunctional catalysis?. ACS Catalysis, 7(1), 520-529.
[23] Bertleff, W., Roeper, M., & Sava, X. (2000). Carbonylation. Ullmann's Encyclopedia of Industrial Chemistry.
[24] Wang, Y., Caiola, A., Robinson, B., Li, Q., & Hu, J. (2020). Hierarchical Galloaluminosilicate MFI Catalysts for Ethane Nonoxidative Dehydroaromatization. Energy & Fuels, 34(3), 3100-3109.
[25] Robinson, B., Caiola, A., Bai, X., Abdelsayed, V., Shekhawat, D., & Hu, J. (2020). Catalytic direct conversion of ethane to value-added chemicals under microwave irradiation. Catalysis Today, 356, 3-10.
[26] Bai, X., Robinson, B., Killmer, C., Wang, Y., Li, L., & Hu, J. (2019). Microwave catalytic reactor for upgrading stranded shale gas to aromatics. Fuel, 243, 485-492.
[27] Samanta, A., Bai, X., Robinson, B., Chen, H., & Hu, J. (2017). Conversion of light alkane to value-added chemicals over ZSM-5/metal promoted catalysts. Industrial & Engineering Chemistry Research, 56(39), 11006-11012.
[28] Robinson, B., Bai, X., Samanta, A., Abdelsayed, V., Shekhawat, D., & Hu, J. (2018). Stability of Fe- and Zn-promoted Mo/ZSM-5 catalysts for ethane dehydroaromatization in cyclic operation mode. Energy & Fuels, 32(7), 7810-7819.
[30] Bai, X., Samanta, A., Robinson, B., Li, L., & Hu, J. (2018). Deactivation Mechanism and Regeneration Study of Ga—Pt Promoted HZSM-5 Catalyst in Ethane Dehydroaromatization. Industrial & Engineering Chemistry Research, 57(13), 4505-4513.
[31] Saito, H., & Sekine, Y. (2020). Catalytic conversion of ethane to valuable products through non-oxidative dehydrogenation and dehydroaromatization. RSC Advances, 10(36), 21427-21453.
[32] Li, J., Liu, Z., Cullen, D. A., Hu, W., Huang, J., Yao, L., . . . & Wang, R. (2019). Distribution and valence state of Ru species on CeO₂ supports: support shape effect and its influence on CO oxidation. ACS Catalysis, 9(12), 11088-11103.
[33] Dagle, R. A., Hu, J., Jones, S. B., Wilcox, W., Frye, J. G., White, J. F., . . . & Wang, Y. (2013). Carbon dioxide conversion to valuable chemical products over composite catalytic systems. Journal of energy chemistry, 22(3), 368-374.

### G. Aspects of the Disclosure

The following listing of exemplary aspects supports and is supported by the disclosure provided herein.

Aspect 1. A multifunctional catalyst comprising: a catalyst support comprising CeO₂, Cr₂O₃, La₂O₃, Y₂O₃, or combinations thereof; a catalyst metal comprising at least one metal selected from Groups 6-11; and optionally a catalyst promoter comprising at least one metal selected from Group 1, and Group 2; wherein the catalyst is capable of interacting with microwave energy in the frequency range of 300 MHz to 50 GHz; wherein the catalyst metal is present in an amount from about 0.1 wt % to about 20 wt %; wherein the catalyst promoter, when present, is in an amount from about 0.1 wt % to about 20 wt %; and wherein the wt % is based on the total weight of the catalyst support, the catalyst metal, and the catalyst promoter, when present.

Aspect 2. The multifunctional catalyst of Aspect 1, wherein the catalyst metal is selected from Ga, Ru, Pt, Pd, Cr, Mn, Fe, Co, Ni, Zn, and combinations thereof.

Aspect 3. The multifunctional catalyst of Aspect 2, wherein the catalyst metal is selected from Ga, Ru, Pt, Cr, Fe, Co, Ni, Zn, and combinations thereof.

Aspect 4. The multifunctional catalyst of Aspect 3, wherein the catalyst metal is selected from Pt, Ga, Ru, Ni, and combinations thereof.

Aspect 5. The multifunctional catalyst of Aspect 3, wherein the catalyst metal is selected from Ru, Pt, Ga, and combinations thereof.

Aspect 6. The multifunctional catalyst of Aspect 3, wherein the catalyst metal is selected from Ru, Pt, Ni, and combinations thereof.

Aspect 7. The multifunctional catalyst of Aspect 3, wherein the catalyst metal is Ru.

Aspect 8. The multifunctional catalyst of Aspect 1, wherein the catalyst metal comprises a single catalyst metal selected from Groups 6-11.

Aspect 9. The multifunctional catalyst of Aspect 8, wherein the single catalyst metal is selected from Ga, Ru, Pt, Pd, Cr, Mn, Fe, Co, Ni, and Zn.

Aspect 10. The multifunctional catalyst of Aspect 9, wherein the single catalyst metal is selected from Ga, Ru, Pt, Cr, Fe, Co, Ni, and Zn.

Aspect 11. The multifunctional catalyst of Aspect 10, wherein the single catalyst metal is selected from Pt, Ga, Ru, and Ni.

Aspect 12. The multifunctional catalyst of Aspect 10, wherein the single catalyst metal is selected from Ru, Pt, and Ga.

Aspect 13. The multifunctional catalyst of Aspect 10, wherein the single catalyst metal is selected from Ru, Pt, and Ni.

Aspect 14. The multifunctional catalyst of Aspect 7, wherein the single catalyst metal is Ru.

Aspect 15. The multifunctional catalyst of Aspect 1, wherein the catalyst metal comprises two catalyst metals selected from Groups 6-11.

Aspect 16. The multifunctional catalyst of Aspect 15, wherein the two catalyst metals are selected from Ga, Ru, Pt, Pd, Cr, Mn, Fe, Co, Ni, and Zn.

Aspect 17. The multifunctional catalyst of Aspect 16, wherein the two catalyst metals are selected from Ga, Ru, Pt, Cr, Fe, Co, Ni, and Zn.

Aspect 18. The multifunctional catalyst of Aspect 17, wherein the two catalyst metals are selected from Pt, Ga, Ru, and Ni.

Aspect 19. The multifunctional catalyst of Aspect 17, wherein the two catalyst metals are selected from Ru, Pt, and Ga.

Aspect 20. The multifunctional catalyst of Aspect 17, wherein the two catalyst metals are selected from Ru, Pt, and Ni.

Aspect 21. The multifunctional catalyst of Aspect 17, wherein the two catalyst metals comprise Ru and Fe.

Aspect 22. The multifunctional catalyst of Aspect 17, wherein the two catalyst metals comprise Ru and Pd.

Aspect 23. The multifunctional catalyst of any one of Aspect 1-Aspect 22, wherein the catalyst metal is present in an amount from about 0.5 wt % to about 18 wt %.

Aspect 24. The multifunctional catalyst of Aspect 23, wherein the catalyst metal is present in an amount from about 0.1 wt % to about 18 wt %.

Aspect 25. The multifunctional catalyst of Aspect 23, wherein the catalyst metal is present in an amount from about 0.1 wt % to about 16 wt %.

Aspect 26. The multifunctional catalyst of Aspect 23, wherein the catalyst metal is present in an amount from about 0.1 wt % to about 14 wt %.

Aspect 27. The multifunctional catalyst of Aspect 23, wherein the catalyst metal is present in an amount from about 0.1 wt % to about 12 wt %.

Aspect 28. The multifunctional catalyst of Aspect 23, wherein the catalyst metal is present in an amount from about 0.1 wt % to about 10 wt %.

Aspect 29. The multifunctional catalyst of Aspect 23, wherein the catalyst metal is present in an amount from about 0.1 wt % to about 8 wt %.

Aspect 30. The multifunctional catalyst of Aspect 23, wherein the catalyst metal is present in an amount from about 0.1 wt % to about 6 wt %.

Aspect 31. The multifunctional catalyst of Aspect 23, wherein the catalyst metal is present in an amount from about 0.5 wt % to about 16 wt %.

Aspect 32. The multifunctional catalyst of Aspect 23, wherein the catalyst metal is present in an amount from about 0.5 wt % to about 14 wt %.

Aspect 33. The multifunctional catalyst of Aspect 23, wherein the catalyst metal is present in an amount from about 0.5 wt % to about 12 wt %.

Aspect 34. The multifunctional catalyst of Aspect 23, wherein the catalyst metal is present in an amount from about 0.5 wt % to about 10 wt %.

Aspect 35. The multifunctional catalyst of Aspect 23, wherein the catalyst metal is present in an amount from about 0.5 wt % to about 8 wt %.

Aspect 36. The multifunctional catalyst of Aspect 23, wherein the catalyst metal is present in an amount from about 0.5 wt % to about 6 wt %.

Aspect 37. The multifunctional catalyst of Aspect 23, wherein the catalyst metal is present in an amount from about 1 wt % to about 18 wt %.

Aspect 38. The multifunctional catalyst of Aspect 23, wherein the catalyst metal is present in an amount from about 1 wt % to about 16 wt %.

Aspect 39. The multifunctional catalyst of Aspect 23, wherein the catalyst metal is present in an amount from about 1 wt % to about 14 wt %.

Aspect 40. The multifunctional catalyst of Aspect 23, wherein the catalyst metal is present in an amount from about 1 wt % to about 12 wt %.

Aspect 41. The multifunctional catalyst of Aspect 23, wherein the catalyst metal is present in an amount from about 1 wt % to about 10 wt %.

Aspect 42. The multifunctional catalyst of Aspect 23, wherein the catalyst metal is present in an amount from about 1 wt % to about 8 wt %.

Aspect 43. The multifunctional catalyst of Aspect 23, wherein the catalyst metal is present in an amount from about 1 wt % to about 6 wt %.

Aspect 44. The multifunctional catalyst of Aspect 23, wherein the catalyst metal is present in an amount from about 2 wt % to about 18 wt %.

Aspect 45. The multifunctional catalyst of Aspect 23, wherein the catalyst metal is present in an amount from about 2 wt % to about 16 wt %.

Aspect 46. The multifunctional catalyst of Aspect 23, wherein the catalyst metal is present in an amount from about 2 wt % to about 14 wt %.

Aspect 47. The multifunctional catalyst of Aspect 23, wherein the catalyst metal is present in an amount from about 2 wt % to about 12 wt %.

Aspect 48. The multifunctional catalyst of Aspect 23, wherein the catalyst metal is present in an amount from about 2 wt % to about 10 wt %.

Aspect 49. The multifunctional catalyst of Aspect 23, wherein the catalyst metal is present in an amount from about 2 wt % to about 8 wt %.

Aspect 50. The multifunctional catalyst of Aspect 23, wherein the catalyst metal is present in an amount from about 2 wt % to about 6 wt %.

Aspect 51. The multifunctional catalyst of Aspect 23, wherein the catalyst metal is present in an amount from about 4 wt % to about 18 wt %.

Aspect 52. The multifunctional catalyst of Aspect 23, wherein the catalyst metal is present in an amount from about 4 wt % to about 16 wt %.

Aspect 53. The multifunctional catalyst of Aspect 23, wherein the catalyst metal is present in an amount from about 4 wt % to about 14 wt %.

Aspect 54. The multifunctional catalyst of Aspect 23, wherein the catalyst metal is present in an amount from about 4 wt % to about 12 wt %.

Aspect 55. The multifunctional catalyst of Aspect 23, wherein the catalyst metal is present in an amount from about 4 wt % to about 10 wt %.

Aspect 56. The multifunctional catalyst of Aspect 23, wherein the catalyst metal is present in an amount from about 4 wt % to about 8 wt %.

Aspect 57. The multifunctional catalyst of Aspect 23, wherein the catalyst metal is present in an amount from about 4 wt % to about 6 wt %.

Aspect 58. The multifunctional catalyst of any one of Aspect 1-Aspect 57, wherein the catalyst promoter is present in an amount from about 0.5 wt % to about 18 wt %.

Aspect 59. The multifunctional catalyst of Aspect 23, wherein the catalyst promoter is present in an amount from about 0.5 wt % to about 16 wt %.

Aspect 60. The multifunctional catalyst of Aspect 23, wherein the catalyst promoter is present in an amount from about 0.5 wt % to about 14 wt %.

Aspect 61. The multifunctional catalyst of Aspect 23, wherein the catalyst promoter is present in an amount from about 0.5 wt % to about 12 wt %.

Aspect 62. The multifunctional catalyst of Aspect 23, wherein the catalyst promoter is present in an amount from about 0.5 wt % to about 10 wt %.

Aspect 63. The multifunctional catalyst of Aspect 23, wherein the catalyst promoter is present in an amount from about 0.5 wt % to about 8 wt %.

Aspect 64. The multifunctional catalyst of Aspect 23, wherein the catalyst promoter is present in an amount from about 0.5 wt % to about 6 wt %.

Aspect 65. The multifunctional catalyst of Aspect 23, wherein the catalyst promoter is present in an amount from about 0.5 wt % to about 4 wt %.

Aspect 66. The multifunctional catalyst of Aspect 23, wherein the catalyst promoter is present in an amount from about 0.5 wt % to about 2 wt %.

Aspect 67. The multifunctional catalyst of Aspect 23, wherein the catalyst promoter is present in an amount from about 1 wt % to about 18 wt %.

Aspect 68. The multifunctional catalyst of Aspect 23, wherein the catalyst promoter is present in an amount from about 1 wt % to about 16 wt %.

Aspect 69. The multifunctional catalyst of Aspect 23, wherein the catalyst promoter is present in an amount from about 1 wt % to about 14 wt %.

Aspect 70. The multifunctional catalyst of Aspect 23, wherein the catalyst promoter is present in an amount from about 1 wt % to about 12 wt %.

Aspect 71. The multifunctional catalyst of Aspect 23, wherein the catalyst promoter is present in an amount from about 1 wt % to about 10 wt %.

Aspect 72. The multifunctional catalyst of Aspect 23, wherein the catalyst promoter is present in an amount from about 1 wt % to about 8 wt %.

Aspect 73. The multifunctional catalyst of Aspect 23, wherein the catalyst promoter is present in an amount from about 1 wt % to about 6 wt %.

Aspect 74. The multifunctional catalyst of Aspect 23, wherein the catalyst promoter is present in an amount from about 1 wt % to about 4 wt %.

Aspect 75. The multifunctional catalyst of Aspect 23, wherein the catalyst promoter is present in an amount from about 1 wt % to about 2 wt %.

Aspect 76. The multifunctional catalyst of any one of Aspect 1-Aspect 75, wherein the catalyst promoter is Li, Na, K, Mg, Ca, Ba, Cs, or combination thereof.

Aspect 77. The multifunctional catalyst of Aspect 76, wherein the catalyst promoter is Li.

Aspect 78. The multifunctional catalyst of Aspect 76, wherein the catalyst promoter is Na.

Aspect 79. The multifunctional catalyst of Aspect 76, wherein the catalyst promoter is K.

Aspect 80. The multifunctional catalyst of Aspect 76, wherein the catalyst promoter is Mg.

Aspect 81. The multifunctional catalyst of Aspect 76, wherein the catalyst promoter is Ca.

Aspect 82. The multifunctional catalyst of Aspect 76, wherein the catalyst promoter is Ba.

Aspect 83. The multifunctional catalyst of Aspect 76, wherein the catalyst promoter is Cs.

Aspect 84. The multifunctional catalyst of any one of Aspect 1-Aspect 83, wherein the catalyst promoter is present in an amount from about 0.1 wt % to about 18 wt %.

Aspect 85. The multifunctional catalyst of Aspect 84, wherein the catalyst promoter is present in an amount from about 0.5 wt % to about 18 wt %.

Aspect 86. The multifunctional catalyst of Aspect 84, wherein the catalyst promoter is present in an amount from about 0.5 wt % to about 16 wt %.

Aspect 87. The multifunctional catalyst of Aspect 84, wherein the catalyst promoter is present in an amount from about 0.5 wt % to about 16 wt %.

Aspect 88. The multifunctional catalyst of Aspect 84, wherein the catalyst promoter is present in an amount from about 0.5 wt % to about 14 wt %.

Aspect 89. The multifunctional catalyst of Aspect 84, wherein the catalyst promoter is present in an amount from about 0.5 wt % to about 12 wt %.

Aspect 90. The multifunctional catalyst of Aspect 84, wherein the catalyst promoter is present in an amount from about 0.5 wt % to about 10 wt %.

Aspect 91. The multifunctional catalyst of Aspect 84, wherein the catalyst promoter is present in an amount from about 0.5 wt % to about 8.5 wt %.

Aspect 92. The multifunctional catalyst of Aspect 84, wherein the catalyst promoter is present in an amount from about 0.5 wt % to about 8.0 wt %.

Aspect 93. The multifunctional catalyst of Aspect 84, wherein the catalyst promoter is present in an amount from about 0.5 wt % to about 7.5 wt %.

Aspect 94. The multifunctional catalyst of Aspect 84, wherein the catalyst promoter is present in an amount from about 0.5 wt % to about 7.0 wt %.

Aspect 95. The multifunctional catalyst of Aspect 84, wherein the catalyst promoter is present in an amount from about 0.5 wt % to about 6.5 wt %.

Aspect 96. The multifunctional catalyst of Aspect 84, wherein the catalyst promoter is present in an amount from about 1.0 wt % to about 18 wt %.

Aspect 97. The multifunctional catalyst of Aspect 84, wherein the catalyst promoter is present in an amount from about 1.0 wt % to about 16 wt %.

Aspect 98. The multifunctional catalyst of Aspect 84, wherein the catalyst promoter is present in an amount from about 1.0 wt % to about 16 wt %.

Aspect 99. The multifunctional catalyst of Aspect 84, wherein the catalyst promoter is present in an amount from about 1.0 wt % to about 14 wt %.

Aspect 100. The multifunctional catalyst of Aspect 84, wherein the catalyst promoter is present in an amount from about 1.0 wt % to about 12 wt %.

Aspect 101. The multifunctional catalyst of Aspect 84, wherein the catalyst promoter is present in an amount from about 1.0 wt % to about 10 wt %.

Aspect 102. The multifunctional catalyst of Aspect 84, wherein the catalyst promoter is present in an amount from about 1.0 wt % to about 8.5 wt %.

Aspect 103. The multifunctional catalyst of Aspect 84, wherein the catalyst promoter is present in an amount from about 1.0 wt % to about 8.0 wt %.

Aspect 104. The multifunctional catalyst of Aspect 84, wherein the catalyst promoter is present in an amount from about 1.0 wt % to about 7.5 wt %.

Aspect 105. The multifunctional catalyst of Aspect 84, wherein the catalyst promoter is present in an amount from about 1.0 wt % to about 7.0 wt %.

Aspect 106. The multifunctional catalyst of Aspect 84, wherein the catalyst promoter is present in an amount from about 1.0 wt % to about 6.5 wt %.

Aspect 107. The multifunctional catalyst of Aspect 84, wherein the catalyst promoter is present in an amount from about 2 wt % to about 6 wt %.

Aspect 108. The multifunctional catalyst of any one of Aspect 1-Aspect 107, wherein the catalyst metal is present in an amount from about 1 wt % to about 8 wt %.

Aspect 109. The multifunctional catalyst of Aspect 108, wherein the catalyst promoter is present in an amount from about 2 wt % to about 6 wt %.

Aspect 110. The multifunctional catalyst of Aspect 108, wherein the catalyst promoter is present in an amount from about 3 wt % to about 5 wt %.

Aspect 111. The multifunctional catalyst of Aspect 108, wherein the catalyst promoter is present in an amount from about 3.9 wt % to about 4.9 wt %.

Aspect 112. The multifunctional catalyst of any one of Aspect 1-Aspect 111, wherein the total wt % of both the catalyst metal and the catalyst promoter is from about 1 wt % to about 30 wt %.

Aspect 113. The multifunctional catalyst of Aspect 112, wherein the total wt % of both the catalyst metal and the catalyst promoter is from about 1 wt % to about 25 wt %.

Aspect 114. The multifunctional catalyst of Aspect 112, wherein the total wt % of both the catalyst metal and the catalyst promoter is from about 1 wt % to about 20 wt %.

Aspect 115. The multifunctional catalyst of Aspect 112, wherein the total wt % of both the catalyst metal and the catalyst promoter is from about 1 wt % to about 15 wt %.

Aspect 116. The multifunctional catalyst of Aspect 112, wherein the total wt % of both the catalyst metal and the catalyst promoter is from about 1 wt % to about 150 wt %.

Aspect 117. The multifunctional catalyst of Aspect 112, wherein the total wt % of both the catalyst metal and the catalyst promoter is from about 1.5 wt % to about 20 wt %.

Aspect 118. The multifunctional catalyst of Aspect 112, wherein the total wt % of both the catalyst metal and the catalyst promoter is from about 2 wt % to about 20 wt %.

Aspect 119. The multifunctional catalyst of Aspect 112, wherein the total wt % of both the catalyst metal and the catalyst promoter is from about 3 wt % to about 20 wt %.

Aspect 120. The multifunctional catalyst of Aspect 112, wherein the total wt % of both the catalyst metal and the catalyst promoter is from about 4 wt % to about 20 wt %.

Aspect 121. The multifunctional catalyst of Aspect 112, wherein the total wt % of both the catalyst metal and the catalyst promoter is from about 5 wt % to about 20 wt %.

Aspect 122. The multifunctional catalyst of Aspect 112, wherein the total wt % of both the catalyst metal and the catalyst promoter is from about 1.5 wt % to about 15 wt %.

Aspect 123. The multifunctional catalyst of Aspect 112, wherein the total wt % of both the catalyst metal and the catalyst promoter is from about 2 wt % to about 15 wt %.

Aspect 124. The multifunctional catalyst of Aspect 112, wherein the total wt % of both the catalyst metal and the catalyst promoter is from about 3 wt % to about 15 wt %.

Aspect 125. The multifunctional catalyst of Aspect 112, wherein the total wt % of both the catalyst metal and the catalyst promoter is from about 4 wt % to about 15 wt %.

Aspect 126. The multifunctional catalyst of Aspect 112, wherein the total wt % of both the catalyst metal and the catalyst promoter is from about 5 wt % to about 15 wt %.

Aspect 127. The multifunctional catalyst of Aspect 112, wherein the total wt % of both the catalyst metal and the catalyst promoter is from about 1.5 wt % to about 10 wt %.

Aspect 128. The multifunctional catalyst of Aspect 112, wherein the total wt % of both the catalyst metal and the catalyst promoter is from about 2 wt % to about 10 wt %.

Aspect 129. The multifunctional catalyst of Aspect 112, wherein the total wt % of both the catalyst metal and the catalyst promoter is from about 3 wt % to about 10 wt %.

Aspect 130. The multifunctional catalyst of Aspect 112, wherein the total wt % of both the catalyst metal and the catalyst promoter is from about 4 wt % to about 10 wt %.

Aspect 131. The multifunctional catalyst of Aspect 112, wherein the total wt % of both the catalyst metal and the catalyst promoter is from about 5 wt % to about 10 wt %.

Aspect 132. The multifunctional catalyst of any one of Aspect 1-Aspect 131, wherein the multifunctional catalyst has a particle size from about 10 nm to about 50 μm.

Aspect 133. The multifunctional catalyst of any one of Aspect 1-Aspect 132, wherein catalyst support comprises CeO₂.

Aspect 134. The multifunctional catalyst of any one of Aspect 1-Aspect 132, wherein catalyst support comprises La₂O₃.

Aspect 135. The multifunctional catalyst of any one of Aspect 1-Aspect 132, wherein catalyst support comprises Y₂O₃.

Aspect 136. The multifunctional catalyst of any one of Aspect 1-Aspect 132, wherein catalyst support comprises CeO₂ and La₂O₃; and wherein the CeO₂ and La₂O₃ are present in a 1:1 ratio based on weight.

Aspect 137. The multifunctional catalyst of any one of Aspect 1-Aspect 136, wherein catalyst support has a particle size from about 1 nm to about 50 μm.

Aspect 138. The multifunctional catalyst of Aspect 137, wherein catalyst support has a particle size from about 5 nm to about 50 μm.

Aspect 139. The multifunctional catalyst of Aspect 137, wherein catalyst support has a particle size from about 10 nm to about 50 μm.

Aspect 140. The multifunctional catalyst of any one of Aspect 1-Aspect 139, wherein the catalyst support is CeO₂.

Aspect 141. The multifunctional catalyst of any one of Aspect 1-Aspect 139, wherein the catalyst support is Cr₂O₃.

Aspect 142. The multifunctional catalyst of any one of Aspect 1-Aspect 139, wherein the catalyst support is Y₂O₃.

Aspect 143. The multifunctional catalyst of any one of Aspect 1-Aspect 139, wherein the catalyst support is La₂O₃.

Aspect 144. The multifunctional catalyst of any one of Aspect 1-Aspect 143, wherein the catalyst the catalyst metal has a particle size of from about 0.1 nm to about 1 μm.

Aspect 145. The multifunctional catalyst of Aspect 144, wherein the catalyst the catalyst metal has a particle size of from about 1 nm to about 100 nm.

Aspect 146. The multifunctional catalyst of Aspect 144, wherein the catalyst the catalyst metal has a particle size of from about 1 nm to about 50 nm.

Aspect 147. The multifunctional catalyst of Aspect 144, wherein the catalyst the catalyst metal has a particle size of from about 1 nm to about 20 nm.

Aspect 148. The multifunctional catalyst of Aspect 144, wherein the catalyst the catalyst metal has a particle size of from about 1 nm to about 15 nm.

Aspect 149. The multifunctional catalyst of Aspect 144, wherein the catalyst the catalyst metal has a particle size of from about 1 nm to about 10 nm.

Aspect 150. A process for carbon-dioxide assisted dehydroaromatization, the process comprising: providing a reaction chamber within a reactor with a multifunctional catalyst of any one of Aspect 1-Aspect 149; heating the multifunctional catalyst using microwave energy with microwave energy in the frequency range of 300 MHz to 50 GHz; conveying a flow of a reactant gas mixtures into the reaction chamber via an entry port; wherein the reaction chamber pressurizes the reaction chamber to a pressure from about 0.9 atm to about 70 atm; contacting the reactant mixture with the multifunctional catalyst; and reacting the reactant gas mixture in contact with the heterogenous catalyst, thereby providing a product mixture; wherein the multifunctional catalyst has a multifunctional catalyst temperature of from about 100° C. to about 800° C.; wherein the reactant mixture comprises a hydrocarbon and optionally carbon dioxide; and wherein the product mixture comprises hydrogen and at least one aromatic or alkene.

Aspect 151. The process of Aspect 150, wherein the hydrocarbon is a hydrocarbon gas, a plastic, a biomass product, or combinations thereof.

Aspect 152. The process of Aspect 151, wherein the hydrocarbon is a hydrocarbon gas.

Aspect 153. The process of Aspect 151 or Aspect 152, wherein the hydrocarbon gas comprises a C2 hydrocarbon, a C3-C5 alkane, a C6 aromatic, or combinations thereof.

Aspect 154. The process of Aspect 151-Aspect 153, further comprising hydrogen.

Aspect 155. The process of Aspect 151, wherein the plastic is a polyolefin.

Aspect 156. The process of Aspect 155, wherein the polyolefin is a polyethylene, polypropylene, and combinations thereof.

Aspect 157. The process of Aspect 156, wherein the polyethylene is a high-density polyethylene.

Aspect 158. The process of Aspect 156, wherein the polyethylene is a low-density polyethylene.

Aspect 159. The process of any one of Aspect 150-Aspect 158, wherein the reactant mixture is pre-heated to a reactant mixture pre-heat temperature prior to conveying the flow of carbon dioxide into the reaction chamber via an entry port; and wherein the reactant mixture pre-heat temperature is from about 20° C. to about 500° C.

Aspect 160. The process of Aspect 159, wherein the reactant mixture pre-heat temperature is from about 50° C. to about 400° C.

Aspect 161. The process of Aspect 159, wherein the reactant mixture pre-heat temperature is from about 50° C. to about 300° C.

Aspect 162. The process of Aspect 159, wherein the reactant mixture pre-heat temperature is from about 50° C. to about 200° C.

Aspect 163. The process of Aspect 159, wherein the reactant mixture pre-heat temperature is from about 100° C. to about 500° C.

Aspect 164. The process of Aspect 159, wherein the reactant mixture pre-heat temperature is from about 100° C. to about 400° C.

Aspect 165. The process of Aspect 159, wherein the reactant mixture pre-heat temperature is from about 100° C. to about 300° C.

Aspect 166. The process of Aspect 159, wherein the reactant mixture pre-heat temperature is from about 100° C. to about 200° C.

Aspect 167. The process of Aspect 159, wherein the reactant mixture pre-heat temperature is from about 150° C. to about 500° C.

Aspect 168. The process of Aspect 159, wherein the reactant mixture pre-heat temperature is from about 150° C. to about 400° C.

Aspect 169. The process of Aspect 159, wherein the reactant mixture pre-heat temperature is from about 150° C. to about 300° C.

Aspect 170. The process of Aspect 159, wherein the reactant mixture pre-heat temperature is from about 150° C. to about 200° C.

Aspect 171. The process of Aspect 159, wherein the reactant mixture pre-heat temperature is from about 200° C. to about 500° C.

Aspect 172. The process of Aspect 159, wherein the reactant mixture pre-heat temperature is from about 200° C. to about 400° C.

Aspect 173. The process of Aspect 159, wherein the reactant gas mixture pre-heat temperature is from about 200° C. to about 300° C.

Aspect 174. The process of Aspect 159, wherein the reactant mixture pre-heat temperature is from about 250° C. to about 500° C.

Aspect 175. The process of Aspect 159, wherein the reactant mixture pre-heat temperature is from about 250° C. to about 450° C.

Aspect 176. The process of any one of Aspect 150-Aspect 175, wherein the heating the multifunctional catalyst is heating with microwave energy having at a frequency of about 300 MHz to about 50 GHz.

Aspect 177. The process of Aspect 176, wherein the microwave energy has a frequency of about 2 MHz to about 50 GHz.

Aspect 178. The process of Aspect 176, wherein the microwave energy has a frequency of about 2 MHz to about 40 GHz.

Aspect 179. The process of Aspect 176, wherein the microwave energy has a frequency of about 2 MHz to about 30 GHz.

Aspect 180. The process of Aspect 176, wherein the microwave energy has a frequency of about 2 MHz to about 25 GHz.

Aspect 181. The process of Aspect 176, wherein the microwave energy has a frequency of about 2 MHz to about 20 GHz.

Aspect 182. The process of Aspect 176, wherein the microwave energy has a frequency of about 2 MHz to about 15 GHz.

Aspect 183. The process of Aspect 176, wherein the microwave energy has a frequency of about 915 MHz to about 10 GHz.

Aspect 184. The process of Aspect 176, wherein the microwave energy has a frequency of about 4 GHz to about 7 GHz.

Aspect 185. The process of Aspect 176, wherein the microwave energy has a frequency of about 5 GHz to about 7 GHz.

Aspect 186. The process of Aspect 176, wherein the microwave energy has a frequency of about 5 GHz to about 6 GHz.

Aspect 187. The process of Aspect 176, wherein the microwave energy has a frequency of about 0.7 GHz to about 3 GHz.

Aspect 188. The process of Aspect 176, wherein the microwave energy has a frequency of about 0.9 GHz to about 2.5 GHz.

Aspect 189. The process of any one of Aspect 150-Aspect 188, wherein the reaction chamber pressurizes the reaction chamber to a pressure from about 0.9 atm to about 60 atm.

Aspect 190. The process of Aspect 189, where the reaction chamber pressurizes the reaction chamber to a pressure from about 0.9 atm to about 50 atm.

Aspect 191. The process of Aspect 189, where the reaction chamber pressurizes the reaction chamber to a pressure from about 0.9 atm to about 40 atm.

Aspect 192. The process of Aspect 189, where the reaction chamber pressurizes the reaction chamber to a pressure from about 0.9 atm to about 30 atm.

Aspect 193. The process of Aspect 189, where the reaction chamber pressurizes the reaction chamber to a pressure from about 0.9 atm to about 20 atm.

Aspect 194. The process of Aspect 189, where the reaction chamber pressurizes the reaction chamber to a pressure from about 0.9 atm to about 10 atm.

Aspect 195. The process of Aspect 189, where the reaction chamber pressurizes the reaction chamber to a pressure from about 1 atm to about 60 atm.

Aspect 196. The process of Aspect 189, where the reaction chamber pressurizes the reaction chamber to a pressure from about 2 atm to about 60 atm.

Aspect 197. The process of Aspect 189, where the reaction chamber pressurizes the reaction chamber to a pressure from about 5 atm to about 60 atm.

Aspect 198. The process of Aspect 189, where the reaction chamber pressurizes the reaction chamber to a pressure from about 10 atm to about 60 atm.

Aspect 199. The process of any one of Aspect 150-Aspect 198, wherein the multifunctional catalyst temperature is from wherein 350° C. to about 800° C.

Aspect 200. The process of any one of Aspect 150-Aspect 198, wherein the multifunctional catalyst temperature is from about 100° C. to about 700° C.

Aspect 201. The process of Aspect 200, wherein the multifunctional catalyst temperature is from wherein 350° C. to about 700° C.

Aspect 202. The process of Aspect 200, wherein the multifunctional catalyst temperature is from about 350° C. to about 650° C.

Aspect 203. The process of Aspect 200, wherein the multifunctional catalyst temperature is from about 400° C. to about 650° C.

Aspect 204. The process of Aspect 200, wherein the multifunctional catalyst temperature is from about 450° C. to about 650° C.

Aspect 205. The process of Aspect 200, wherein the multifunctional catalyst temperature is from about 500° C. to about 650° C.

Aspect 206. The process of Aspect 200, wherein the multifunctional catalyst temperature is from about 550° C. to about 650° C.

Aspect 207. The process of any one of Aspect 150-Aspect 206, wherein the product mixture comprises hydrogen and one or more of ethylene, acetylene, propylene, butene, butadiene, benzene, toluene, or xylene.

Aspect 208. The process of Aspect 207, the product mixture comprises hydrogen and one or more benzene, toluene, or xylene.

Aspect 209. The process of Aspect 207, the product mixture comprises hydrogen and benzene.

Aspect 210. The process of Aspect 207, the product mixture comprises hydrogen, benzene, toluene, and xylene.

Aspect 211. The process of any one of Aspect 207-Aspect 210, the product mixture has benzene selectivity from about 10 wt % to about 50 wt %.

Aspect 212. The process of Aspect 211, the product mixture has benzene selectivity from about 10 wt % to about 40 wt %.

Aspect 213. The process of Aspect 211, the product mixture has benzene selectivity from about 10 wt % to about 30 wt %.

Aspect 214. The process of Aspect 211, the product mixture has benzene selectivity from about 10 wt % to about 25 wt %.

Aspect 215. The process of Aspect 211, the product mixture has benzene selectivity from about 10 wt % to about 20 wt %.

Aspect 216. The process of any one of Aspect 150-Aspect 211, wherein the reactant mixture comprises ethane.

Aspect 217. The process of Aspect 216, wherein about 30% to about 100% of the ethane is converted.

Aspect 218. The process of Aspect 217, wherein about 30% to about 90% of the ethane is converted.

Aspect 219. The process of Aspect 217, wherein about 40% to about 90% of the ethane is converted.

Aspect 220. The process of Aspect 217, wherein about 30% to about 80% of the ethane is converted.

Aspect 221. The process of Aspect 217, wherein about 40% to about 80% of the ethane is converted.

Aspect 222. The process of Aspect 217, wherein about 30% to about 70% of the ethane is converted.

Aspect 223. The process of Aspect 217, wherein about 40% to about 70% of the ethane undergoes reaction.

Aspect 224. The process of any one of Aspect 150-Aspect 223, wherein about 20 wt % to about 90 wt % of the carbon dioxide is converted.

Aspect 225. The process of Aspect 224, wherein about 20 wt % to about 80 wt % of the carbon dioxide is converted.

Aspect 226. The process of Aspect 224, wherein about 20 wt % to about 70 wt % of the carbon dioxide is converted.

Aspect 227. The process of Aspect 224, wherein about 20 wt % to about 60 wt % of the carbon dioxide is converted.

Aspect 228. The process of Aspect 224, wherein about 20 wt % to about 50 wt % of the carbon dioxide is converted.

Aspect 229. The process of Aspect 224, wherein about 30 wt % to about 90 wt % of the carbon dioxide is converted.

Aspect 230. The process of Aspect 224, wherein about 30 wt % to about 80 wt % of the carbon dioxide is converted.

Aspect 231. The process of Aspect 224, wherein about 30 wt % to about 70 wt % of the carbon dioxide is converted.

Aspect 232. The process of Aspect 224, wherein about 30 wt % to about 60 wt % of the carbon dioxide is converted.

Aspect 233. The process of Aspect 224, wherein about 20 wt % to about 50 wt % of the carbon dioxide is converted.

Aspect 234. The process of any one of Aspect 150-Aspect 233, wherein the multifunctional catalyst has at least 90% of baseline activity for a period of at least about 300 minutes.

Aspect 235. The process of Aspect 234, wherein the multifunctional catalyst has at least 90% of baseline activity for a period from about 5 hours to about 100 hours.

Aspect 236. The process of Aspect 234, wherein the multifunctional catalyst has at least 90% of baseline activity for a period from about 5 hours to about 90 hours.

Aspect 237. The process of Aspect 234, wherein the multifunctional catalyst has at least 90% of baseline activity for a period from about 5 hours to about 80 hours.

Aspect 238. The process of Aspect 234, wherein the multifunctional catalyst has at least 90% of baseline activity for a period from about 5 hours to about 70 hours.

Aspect 239. The process of Aspect 234, wherein the multifunctional catalyst has at least 90% of baseline activity for a period from about 5 hours to about 60 hours.

Aspect 240. The process of Aspect 234, wherein the multifunctional catalyst has at least 90% of baseline activity for a period from about 5 hours to about 50 hours.

Aspect 241. The process of Aspect 234, wherein the multifunctional catalyst has at least 90% of baseline activity for a period from about 5 hours to about 40 hours.

Aspect 242. The process of Aspect 234, wherein the multifunctional catalyst has at least 90% of baseline activity for a period from about 5 hours to about 30 hours.

Aspect 243. The process of Aspect 234, wherein the multifunctional catalyst has at least 90% of baseline activity for a period from about 5 hours to about 20 hours.

Aspect 244. The process of Aspect 234, wherein the multifunctional catalyst has at least 90% of baseline activity for a period from about 5 hours to about 10 hours.

Aspect 245. The process of Aspect 234, wherein the multifunctional catalyst has at least 90% of baseline activity for a period from about 10 hours to about 100 hours.

Aspect 246. The process of Aspect 234, wherein the multifunctional catalyst has at least 90% of baseline activity for a period from about 10 hours to about 90 hours.

Aspect 247. The process of Aspect 234, wherein the multifunctional catalyst has at least 90% of baseline activity for a period from about 10 hours to about 80 hours.

Aspect 248. The process of Aspect 234, wherein the multifunctional catalyst has at least 90% of baseline activity for a period from about 10 hours to about 70 hours.

Aspect 249. The process of Aspect 234, wherein the multifunctional catalyst has at least 90% of baseline activity for a period from about 10 hours to about 60 hours.

Aspect 250. The process of Aspect 234, wherein the multifunctional catalyst has at least 90% of baseline activity for a period from about 10 hours to about 50 hours.

Aspect 251. The process of Aspect 234, wherein the multifunctional catalyst has at least 90% of baseline activity for a period from about 10 hours to about 40 hours.

Aspect 252. The process of Aspect 234, wherein the multifunctional catalyst has at least 90% of baseline activity for a period from about 10 hours to about 30 hours.

Aspect 253. The process of Aspect 234, wherein the multifunctional catalyst has at least 90% of baseline activity for a period from about 10 hours to about 20 hours.

Aspect 254. The process of Aspect 234, wherein the multifunctional catalyst has at least 90% of baseline activity for a period from about 300 minutes to about 900 minutes.

Aspect 255. The process of Aspect 234, wherein the multifunctional catalyst has at least 90% of baseline activity for a period from about 300 minutes to about 800 minutes.

Aspect 256. The process of Aspect 234, wherein the multifunctional catalyst has at least 90% of baseline activity for a period from about 300 minutes to about 700 minutes.

Aspect 257. The process of Aspect 234, wherein the multifunctional catalyst has at least 90% of baseline activity for a period from about 300 minutes to about 600 minutes.

Aspect 258. The process of any one of Aspect 150-Aspect 257, wherein the reactant mixture does not comprise carbon dioxide.

Aspect 259. The process of any one of Aspect 150-Aspect 257, wherein the reactant mixture comprises carbon dioxide in an amount of at least 0.1 wt %.

Aspect 260. The process of Aspect 259, wherein the reactant mixture comprises carbon dioxide in an amount from about 0.1 wt % to about 95 wt %.

Aspect 261. The process of Aspect 259, wherein the reactant mixture comprises carbon dioxide in an amount from about 1 wt % to about 95 wt %.

Aspect 262. The process of Aspect 259, wherein the reactant mixture comprises carbon dioxide in an amount from about 5 wt % to about 95 wt %.

Aspect 263. The process of Aspect 259, wherein the reactant mixture comprises carbon dioxide in an amount from about 10 wt % to about 95 wt %.

Aspect 264. The process of Aspect 259, wherein the reactant mixture comprises carbon dioxide in an amount from about 15 wt % to about 95 wt %.

Aspect 265. The process of Aspect 259, wherein the reactant mixture comprises carbon dioxide in an amount from about 20 wt % to about 95 wt %.

Aspect 266. The process of Aspect 259, wherein the reactant mixture comprises carbon dioxide in an amount from about 25 wt % to about 95 wt %.

Aspect 267. The process of Aspect 259, wherein the reactant mixture comprises carbon dioxide in an amount from about 0.1 wt % to about 90 wt %.

Aspect 268. The process of Aspect 259, wherein the reactant mixture comprises carbon dioxide in an amount from about 1 wt % to about 90 wt %.

Aspect 269. The process of Aspect 259, wherein the reactant mixture comprises carbon dioxide in an amount from about 5 wt % to about 90 wt %.

Aspect 270. The process of Aspect 259, wherein the reactant mixture comprises carbon dioxide in an amount from about 10 wt % to about 90 wt %.

Aspect 271. The process of Aspect 259, wherein the reactant mixture comprises carbon dioxide in an amount from about 15 wt % to about 90 wt %.

Aspect 272. The process of Aspect 259, wherein the reactant mixture comprises carbon dioxide in an amount from about 20 wt % to about 90 wt %.

Aspect 273. The process of Aspect 259, wherein the reactant mixture comprises carbon dioxide in an amount from about 25 wt % to about 90 wt %.

Aspect 274. The process of Aspect 259, wherein the reactant mixture comprises carbon dioxide in an amount from about 0.1 wt % to about 80 wt %.

Aspect 275. The process of Aspect 259, wherein the reactant mixture comprises carbon dioxide in an amount from about 1 wt % to about 80 wt %.

Aspect 276. The process of Aspect 259, wherein the reactant mixture comprises carbon dioxide in an amount from about 5 wt % to about 80 wt %.

Aspect 277. The process of Aspect 259, wherein the reactant mixture comprises carbon dioxide in an amount from about 10 wt % to about 80 wt %.

Aspect 278. The process of Aspect 259, wherein the reactant mixture comprises carbon dioxide in an amount from about 15 wt % to about 80 wt %.

Aspect 279. The process of Aspect 259, wherein the reactant mixture comprises carbon dioxide in an amount from about 20 wt % to about 80 wt %.

Aspect 280. The process of Aspect 259, wherein the reactant mixture comprises carbon dioxide in an amount from about 25 wt % to about 80 wt %.

Aspect 281. The process of Aspect 259, wherein the reactant mixture comprises carbon dioxide in an amount from about 0.1 wt % to about 70 wt %.

Aspect 282. The process of Aspect 259, wherein the reactant mixture comprises carbon dioxide in an amount from about 1 wt % to about 70 wt %.

Aspect 283. The process of Aspect 259, wherein the reactant mixture comprises carbon dioxide in an amount from about 5 wt % to about 70 wt %.

Aspect 284. The process of Aspect 259, wherein the reactant mixture comprises carbon dioxide in an amount from about 10 wt % to about 70 wt %.

Aspect 285. The process of Aspect 259, wherein the reactant mixture comprises carbon dioxide in an amount from about 15 wt % to about 70 wt %.

Aspect 286. The process of Aspect 259, wherein the reactant mixture comprises carbon dioxide in an amount from about 20 wt % to about 70 wt %.

Aspect 287. The process of Aspect 259, wherein the reactant mixture comprises carbon dioxide in an amount from about 25 wt % to about 70 wt %.

Aspect 288. The process of Aspect 259, wherein the reactant mixture comprises carbon dioxide in an amount less than or equal to 95 wt %.

Aspect 289. The process of Aspect 259, wherein the reactant mixture comprises carbon dioxide in an amount less than or equal to 90 wt %.

Aspect 290. The process of Aspect 259, wherein the reactant mixture comprises carbon dioxide in an amount less than or equal to 80 wt %.

Aspect 291. The process of Aspect 259, wherein the reactant mixture comprises carbon dioxide in an amount less than or equal to 70 wt %.

Aspect 292. The process of Aspect 259, wherein the reactant mixture comprises carbon dioxide in an amount less than or equal to 60 wt %.

Aspect 293. The process of Aspect 259, wherein the reactant mixture comprises carbon dioxide in an amount less than or equal to 50 wt %.

Aspect 294. The process of Aspect 259, wherein the reactant mixture comprises carbon dioxide in an amount less than or equal to 40 wt %.

Aspect 295. The process of Aspect 259, wherein the reactant mixture comprises carbon dioxide in an amount less than or equal to 30 wt %.

Aspect 296. The process of Aspect 259, wherein the reactant mixture comprises carbon dioxide in an amount less than or equal to 25 wt %.

Aspect 297. The process of Aspect 259, wherein the reactant mixture comprises carbon dioxide in an amount less than or equal to 20 wt %.

Aspect 298. The process of Aspect 259, wherein the reactant mixture comprises carbon dioxide in an amount less than or equal to 15 wt %.

Aspect 299. The process of Aspect 259, wherein the reactant mixture comprises carbon dioxide in an amount less than or equal to 10 wt %.

Aspect 300. The process of Aspect 259, wherein the reactant mixture comprises carbon dioxide in an amount less than or equal to 5 wt %.

Aspect 301. The process of Aspect 259, wherein the reactant mixture comprises carbon dioxide in an amount less than or equal to 1 wt %.

In various aspects, the disclosed process utilizes variable microwave energy and a catalyst to efficiently synthesize ammonia from a reactant gas mixture comprising hydrogen and nitrogen.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure

### H. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Preparation of Disclosed Catalysts.

The preparation of a disclosed catalyst used in the studies described herein below used cerium (IV) oxide (99.95%, CeO₂, Sigma-Aldrich); ruthenium (III) nitrosylnitrate (31.3% Ru, Ru(NO)(NO₃)₃, Alfa Aesar); and cesium nitrate (99.8%, CsNO₃, Alfa Aesar).

The disclosed CsRu/CeO₂ catalyst referenced in the studies disclosed below comprised 4 wt % Ru (catalyst metal) and 2 wt % Cs (catalyst promoter) was prepared by incipient wetness method on a CeO₂ catalyst support. Briefly, 5 g CeO₂ (99.95%, Sigma-Aldrich) support was wet impregnated with a 10 ml solution of 0.64 g Ru(NO)(NO₃)₃ (31.3% Ru, Alfa Aesar) and 0.15 g CsNO₃ (99.0%, Fisher Chemical). After stirring for 2 h, the sample was dried at 80° C. overnight and then calcined at 550° C. for 4 h.

2. Thermally Heated Reactor: H₂ Production Through Ethane DHA in the Presence of CO₂.

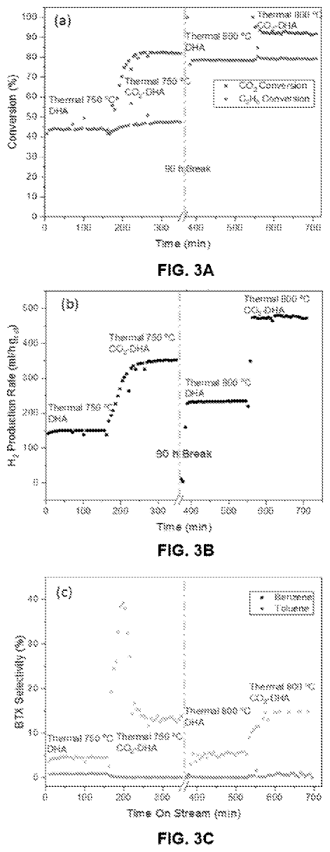

A disclosed multifunctional CsRu/CeO₂ catalyst was prepared as described herein above, and used to assess the efficiency in a disclosed DHA and CO₂/DHA process utilizing a thermally heated reactor. FIGS. 3A-3C show the effect of temperature and the presence of CO₂ on ethane DHA over a disclosed multifunctional CsRu/CeO₂ catalyst in thermally heated reactor. The data show that the disclosed multifunctional CsRu/CeO₂ catalyst is highly active for the conversion of ethane and CO₂, but relatively sensitive to the temperature increase. As shown in FIG. 3A, ethane conversion increased from 43% to 80% with the increase in temperature from 750° C. to 800° C. in the absence of CO₂. Ethane conversion improved in the presence of CO₂ (in this study, ethane/CO₂ molar ratio was 1:1). The data further show that in addition to improved ethane conversion, the disclosed CsRu/CeO₂ catalyst showed high activity for CO₂ conversion. The CO₂ conversion reached 80% at 750° C. in CO₂-DHA and increased to 90% at 800° C. It should be noted that such a high CO₂ conversion is thermodynamically impossible in a conventional CO₂ and ethane process. In fact, the highest CO₂ conversion reported in literature was 50% while most studies show less than 20% CO₂ conversion. [Refs. 11, 31] The data further show that the H₂ production rate significantly improved in the presence of CO₂. As shown in FIG. 3B, the H₂ production rate in CO₂-DHA process was two orders of magnitude higher than that in the DHA process. Meanwhile, the BTX selectivity also significantly improved in the presence of CO₂. As shown in FIG. 3C, the BTX selectivity in the disclosed CO₂-DHA process was three orders of magnitude higher than in the DHA process. Beside the high activity, the disclosed multifunctional CsRu/CeO₂ catalyst exhibited the long-term stability. As shown in FIGS. 3A-3C, after 700 min time-on-stream, the disclosed CsRu/CeO₂ catalyst maintained high activity without any sign of deactivation, even with variation of reaction conditions (temperature and feeding) and shut-down/start-up breaks.

3. Microwave Enhanced H₂ Production Via Ethane DHA.

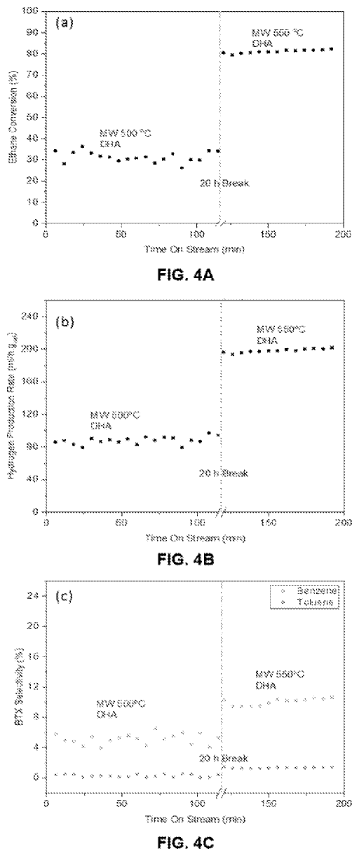

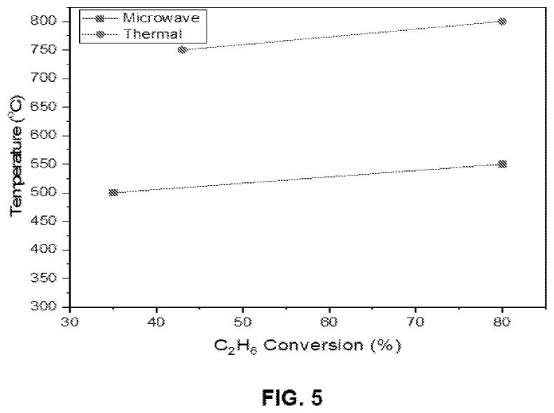

The studies describe above were repeated but using microwave heated reactor instead of thermally heated reactor, i.e., a disclosed multifunctional CsRu/CeO₂ catalyst was prepared as described herein above and used to assess the efficiency in a disclosed DHA and CO₂/DHA process utilizing a microwave heated reactor. As shown in FIG. 4A, ethane conversion reached 35% at 500° C. in microwave energy reactor, and was sensitive to temperature reaching 80% at 550° C., which can only be achieved at 800° C. by conventional thermal heating (see study above). Meanwhile, the H₂ production rate and BTX selectivity also improved as shown in FIGS. 4B-4C. The data show that benzene selectivity reached 10%, which is nearly two orders of magnitude higher than in a conventional thermally heated fixed-bed reactor. Under microwave energy condition, the disclosed multifunctional CsRu/CeO₂ catalyst demonstrated long-term stability, i.e., the data show that after more than 200 min reaction, the disclosed CsRu/CeO₂ catalyst retained considerable activity for ethane conversion and retained a high production rate for H₂ and BTX aromatics. The data show that the H₂ production rate and BTX aromatics selectivity were further improved in the presence of CO₂. As shown in FIG. 5, to reach the same ethane conversion, the microwave energy reactor can be operated at temperature 250° C. lower a thermally heated reactor. The lower temperature operation in microwave energy reactor should associated with a significant energy savings and decreased coke formation rate.

4. Multifunctional CSRU/CeO₂ Catalyst Characterization.

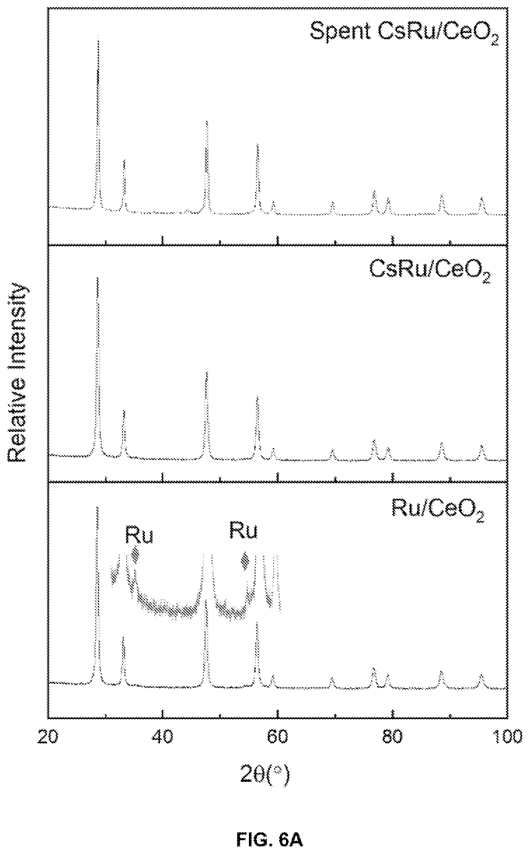

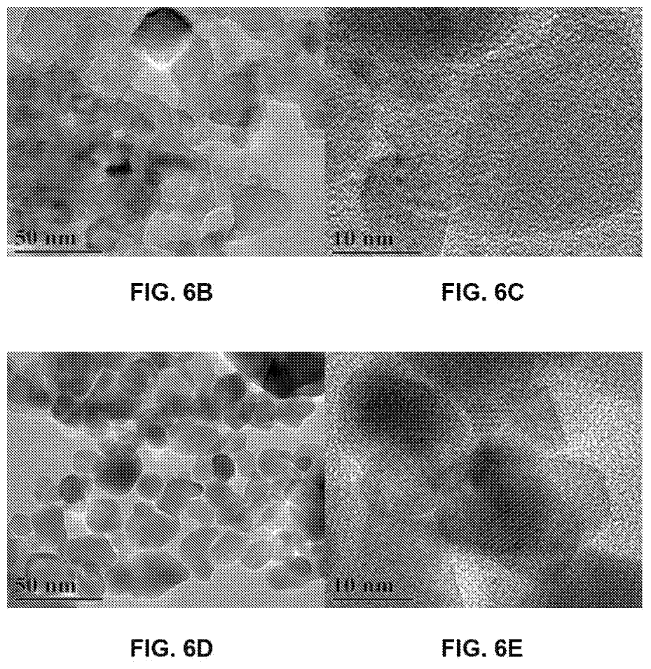

The multifunctional CsRu/CeO₂ catalyst were characterized in part, and the data are shown in FIGS. 6A-6C. FIG. 6A shows representative x-ray diffraction data of a disclosed CsRu/CeO₂ catalyst. The data show that the Ru diffraction peaks are hard to observed over CsRu/CeO₂ catalysts, suggesting the presence of small particle size of Ru over CeO₂ supported catalysts. FIG. 6B shows a representative transmission electron micrograph image of a disclosed CsRu/CeO₂ catalyst. FIG. 6C shows a representative high-resolution transmission electron micrograph image of a disclosed CsRu/CeO₂ catalyst. The images in FIGS. 6B-6C show that Ru particles are not visible on CeO₂ support, even with high-resolution TEM (HRTEM). The image data suggests that formation of the active phase results in highly dispersed Ru nanoparticles, which is likely associated with the improved catalytic activity of the disclosed multifunctional catalysts.

5. Representative Data—Ethane Oxidative Dehydrogenation by CO₂ Over Stable CSRU/CeO₂ Catalyst

Disclosed Catalyst Synthesis. A disclosed Ru/CeO₂ catalyst containing 4 wt. % Ru was prepared by the conventional an incipient wetness method. Typically, 2.5 g CeO₂ (99.95%, Sigma-Aldrich) support was wet impregnated with a 5 ml solution containing 0.32 g Ru (NO)(NO₃)₃ (≥31.3% Ru, Alfa Aesar). After stirring for 2 h, the sample was dried at 80° C. overnight followed by calcination in air at 550° C. for 4 h.

A disclosed CsRu/CeO₂ catalyst containing 4 wt. % Ru and 2 wt. % Cs promoter was prepared by an incipient wetness method. Typically, 2.5 g CeO₂ (99.95%, Sigma-Aldrich) support was wet impregnated with a 5 ml solution of 0.32 g Ru (NO)(NO₃)₃ (≥31.3% Ru, Alfa Aesar) and 0.075 g CsNO₃ (≥99.0%, Fisher Chemical). After stirring for 2 h, the sample was dried at 80° C. overnight followed by calcination in air at 550° C. for 4 h.

Catalyst Characterization. X-ray diffraction (XRD) measurement was carried out on a PANalytical X'Pert Pro X-ray Diffractometer (XRD) in the Bragg-Brentano geometry using Cu-kα radiation (k-alpha1 at 1.54056 A and k-alpha2 at 1.54439 A with 2:1 ratio) at 45 kV and 40 mA in the 2θ range from 10 to 100° at a step size of 0.017 degree and a scan rate of 5°/min using a 1D silicon strip X-ray detector.

Transmission electron microscopy (TEM) measurements were carried out on an FEI Tecnai F20 Super-Twin, operated at 200 kV. The TEM samples were prepared by suspending the catalyst in ethanol and dispersing it onto a copper grid coated with lacey carbon film before TEM analysis.

H₂ temperature-programmed reduction (H₂-TPR) was carried out in a Micromeritics Autochem 2950 instrument. In the TPR measurement, 0.2 g of sample was first pretreated at 300° C. for 120 min in a flow of N₂ (30 mL/min) to dry the sample. After drying the sample was cooled to 50° C. in a flow of Helium and hold for 10 minutes. Then the gas flow was switched to H₂/Ar (10% H₂ in Ar, 30 mL/min), held for 20 minutes. The sample was then heated to 850° C. at a rate of 10° C./min in a flow of H₂/Ar.

X-ray Photoelectron Spectroscopy (XPS) measurement was performed using a commercial Physical Electronics PHI 5000 VersaProbe system. The system is equipped with a monochromatic Al K-alpha X-ray source at 1486.6 eV with 100 um beam size. All XPS measurements were carried out at room temperature at a pressure below 10⁻⁸ Torr. Compositional survey scans were obtained using a pass energy of 117.4 eV and energy step of 0.5 eV. High-resolution detailed scans of each element were acquired using a pass energy of 23.5 eV and energy step of 0.1 eV. The binding energies were measured by referencing the C(1s) binding energy of adventitious carbon contamination taken to be 284.8 eV.

The average Ru particles size was measured through chemisorption technique using carbon monoxide (CO) as the adsorbate, which is typically used for Ru metal particle size measurement. The measurements were performed in a Micromeritics Autochem 2950 instrument at 35° C. The samples were reduced with H₂ at 470° C. for 10 h prior to the measurements. The chemisorption data was used to calculate the Ru particle size and dispersion.

Thermogravimetric analysis (TGA) was carried out in a TA Instruments SDT 650 to conduct the redox property at different temperature levels. The sample was heated from 50° C. to the target temperature, at a heating rate of 10° C./min in a flow of 100 ml/min of air. The sample was held at the temperature for 180 minutes. The reduction process was conducted by heating the sample from 50° C. to 500° C., 600° C., 700° C., 750° C., and 800° C. at a heating rate of 10° C./min under hydrogen at a flow rate of 100 ml/min. The sample was held at each temperature for 210 minutes. Meanwhile, the heat flow was recorded by DSC function in the TGA instrument.

Catalytic Activity Evaluation. ODH and EDH experiments were carried out in a continuous flow fixed-bed reactor (10 mm i.d. and 44.5 cm long quartz tube) at atmospheric pressure. Before the reaction, we tuned the PID control of furnace and check the isothermal zone of the furnace. The furnace has a larger isothermal zone of around 1000 cm³ whereas the catalyst bed volume is around 0.8 cm³. In control runs, we checked the isothermicity of the 10 mm catalyst bed, it was uniform no temperature gradient was observed.

In a typical test, 1 gram of catalyst was placed in the reactor and the reaction temperature was measured with a K-type thermocouple installed in the catalyst bed. The catalyst temperature was increased from room temperature to 600° C., 700° C., 750° C., and 800° C. at 10° C./min ramping rate. In each temperature step, the catalyst temperature was held for one hour. The effects of process parameters, gas hourly space velocity (GHSV), C₂H₆ and CO₂ mole ratio, and temperature were investigated. The composition of the outlet gas was analyzed by on-line gas chromatography (4-channel Inficon Fusion micro gas chromatography).

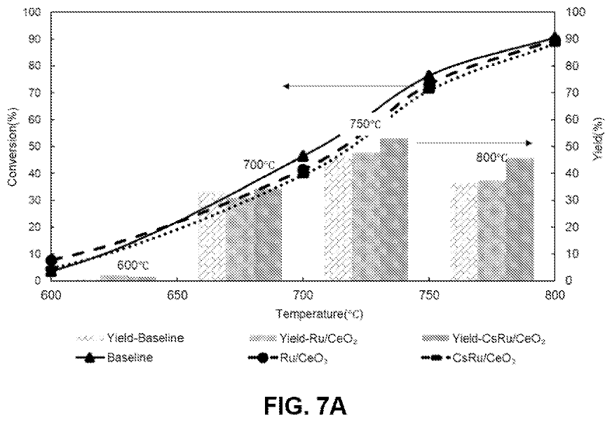

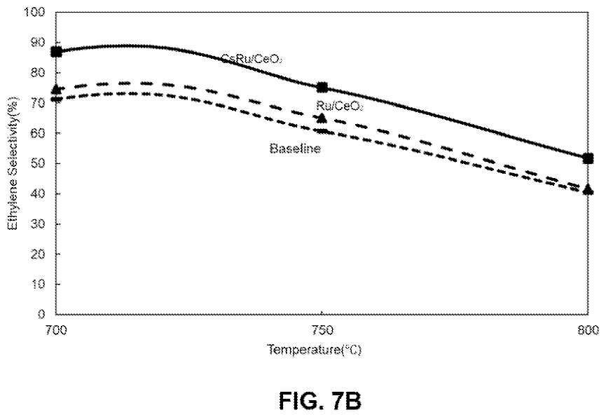

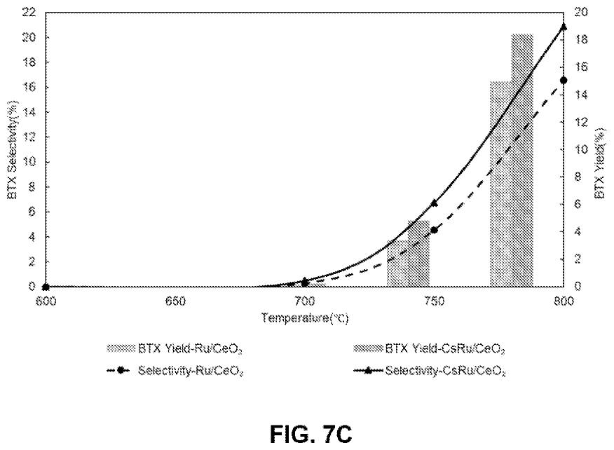

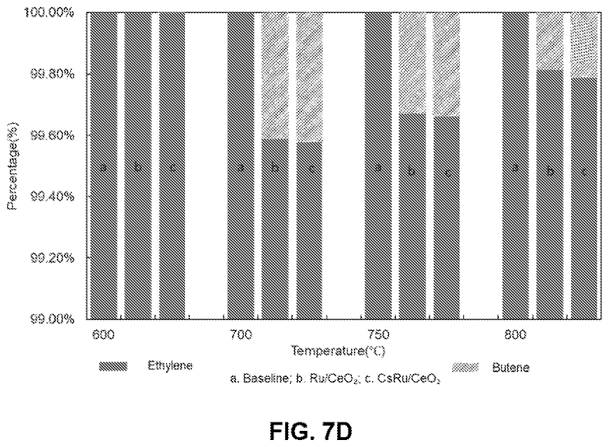

Results and Discussion of Example 5: Effect of Disclosed Catalysts. To determine the contribution of the Cs promotor to the catalytic activity, the disclosed Ru/CeO₂ and CsRu/CeO₂ catalysts were tested under the same reaction conditions. The feedstocks GHSV was set at 1200 h⁻¹ with 50% C₂H₆ and 50% N₂ as inert. FIGS. 7A-7D show the ethane dehydrogenation performance over disclosed Ru/CeO₂ and CsRu/CeO₂ catalysts at 600, 700, 750, and 800° C. The baseline test was performed in the absence of a catalyst but operated under the same reaction conditions.

As shown in FIG. 7A, ethane conversion was not significantly different between the two catalysts, although ethane conversion over the disclosed CsRu/CeO₂ was somewhat lower than the disclosed Ru/CeO₂. Although ethane conversion over both catalysts was slightly lower than that in the baseline test, the ethylene yield was improved by using a catalyst, e.g., see data for the disclosed CsRu/CeO₂. At a reaction temperature of 750° C., the yield of ethylene reached 53.2% over the disclosed CsRu/CeO₂, 47.6% over the disclosed Ru/CeO₂, and 46.3% without a catalyst. Without wishing to be bound by a particular theory, it is believed this may be due to the selectivity to ethylene was improved in the presence of a catalyst, e.g., see data for the disclosed CsRu/CeO₂ catalyst. As shown in FIG. 7B, at 700° C., the ethylene selectivity increased from 71.2% in baseline to 74.6% and 87.0% over Ru/CeO₂ and CsRu/CeO₂, respectively. The selectivity of ethylene decreased when the reaction temperature was further increased. Without wishing to be bound by a particular theory, it is believed this may be due to the aromatization of ethylene (3C₂H₄=C₆H₆+3H₂). As shown in FIG. 7C, the BTX (Benzene, Toluene, and Xylene) aromatics were formed at relatively high reaction temperatures (>700° C.). The selectivity and the yield of BTX were increased with an increase in reaction temperature, reaching the highest level at 800° C. over both catalysts. CsRu/CeO₂ exhibited somewhat better aromatization activity than Ru/CeO₂. The yield of BTX reached 18.4% with 20.7% selectivity over the disclosed CsRu/CeO₂ at 800° C., whereas over the disclosed Ru/CeO₂ catalyst, the yield of BTX and selectivity were 14.9% with 16.6%, respectively.

Besides ethylene and aromatics products, C₄ olefins were detected in the products when Ru/CeO₂ and CsRu/CeO₂ were used as disclosed catalysts. In contrast, in the baseline test without using a catalyst, ethylene was the only product detected. As shown in FIG. 7D, the butene selectivity reaches the highest at 700° C. over both catalysts and decreased when the temperature was further increased. Obviously, the CsRu/CeO₂ catalyst is a promising catalyst for the ethane dehydrogenation process.

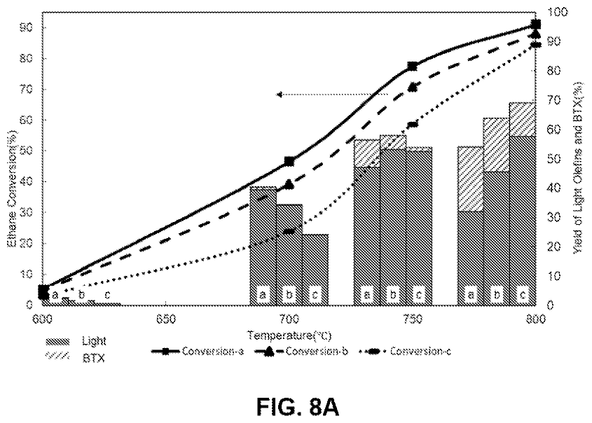

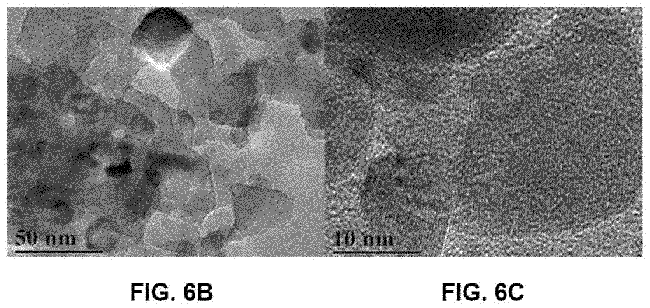

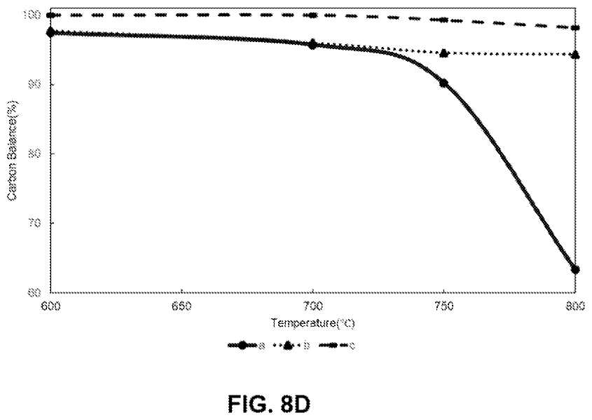

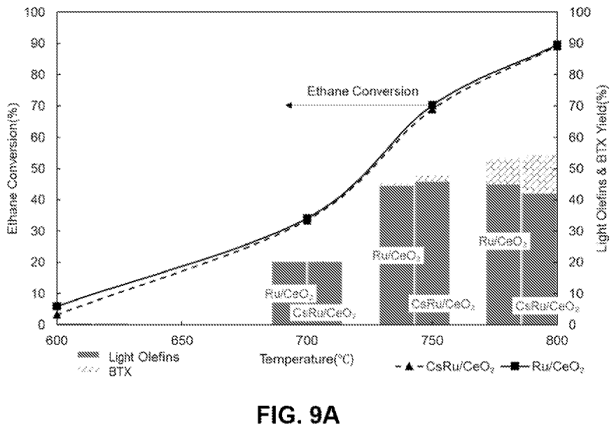

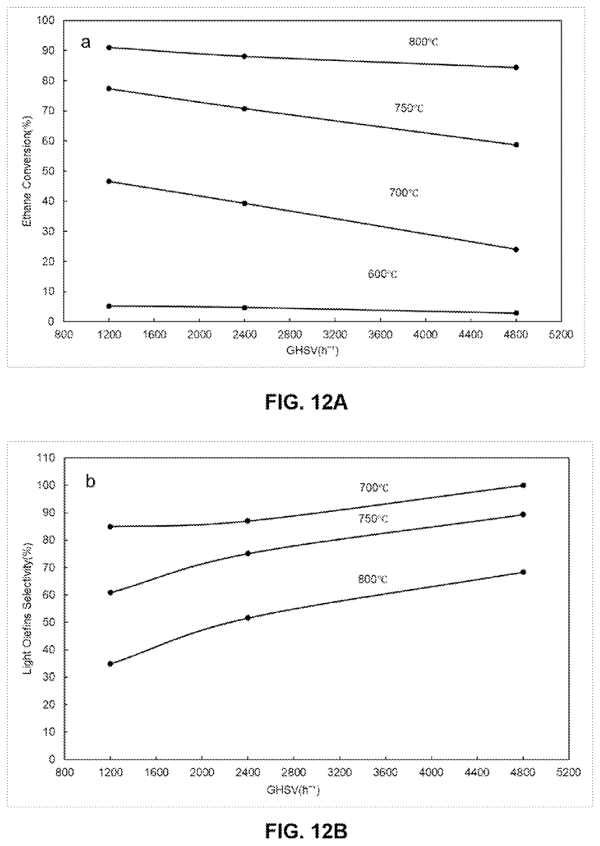

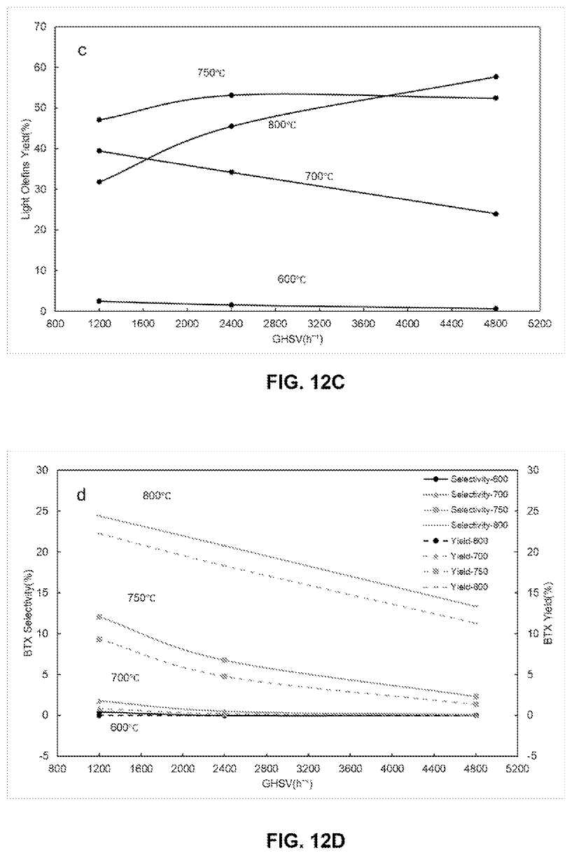

Results and Discussion of Example 5: Effect of Process Parameters. To optimize the EDH process over a disclosed CsRu/CeO₂ catalyst, the effect of GHSV was investigated. The C₂H₆ was diluted to the same concentration with N₂ (50% of C₂H₆ and 50% of N₂) and three different flow rates were assessed, i.e., 1200 h⁻¹, 2400 h⁻¹ and 4800 h⁻¹. In EDH, ethane conversion and product selectivity were significantly affected by the reactant flow rate (FIG. 12). As shown in FIG. 8A and FIG. 12A, ethane conversion is decreased with an increase in GHSV at all temperatures. Meanwhile, ethane conversion was increased with higher reaction temperature. At a relatively lower reaction temperature (600-700° C.), the main product consisted of light olefins, and the yield decreased with increase in flow rate. At relative high reaction temperatures (700-800° C.), the BTX was formed with higher selectivity at lower flow rate. For instance, as shown in FIGS. 12C-12D, at higher reaction temperatures (>700° C.), the yield of light olefins was increased with an increase in GHSV, whereas the BTX yield is decreased. When the reaction temperature reached 800° C., the yield of light olefins increased from 31.8% to 51.7% when the total gas flow rate was increased from 1200 h⁻¹ to 4800 h⁻¹. In contrast, the yield of BTX was decreased from 22.2% to 11.3%. As shown in FIG. 8B, the BTX selectivity increased with an increase in reaction temperature and is decreased with increase in flow rate. In contrast, the selectivity of light olefins was decreased with an increase in reaction temperature but was increased with the increase in flow rate (FIG. 12B). Without wishing to be bound by a particular theory, it is believed this may be due to the increase in residence time, which allowed ethylene to have more contact time on the catalyst surface to form aromatics. It is worth to noting that the selectivity of light olefins reached 100% at 700° C. when C₂H₆ was 2400 h⁻¹ (FIG. 8B). The data herein demonstrate that the disclosed methods can provide a means of controlling the product selectivity when olefins are the only desired products.

FIG. 8C shows the distribution of light olefins at different flow rates and temperatures. For instance, when the GHSV was set at 1200 h⁻¹, ethylene was predominantly detected at 600° C., propylene was detected as the temperature was higher. As GHSV increased to 2400 h⁻¹ and 4800 h⁻¹, butene was detected when temperature was higher than 600° C., but it decreased when temperature continued to increase and flow rate was further increased to 4800 h⁻¹. When the GHSV was set at very low value, the residence time was long enough to enable aromatization of ethylene (FIG. 8A). When flow rate was increased, the residence time of reactant decreased, therefore ethylene underwent dimerization to form C₄ olefins rather than aromatics. The carbon balance based on feed and gas product analyses for the three different flow rates was measured. As shown in FIG. 8D, the carbon balance is almost 100% when the GHSV was 4800 h⁻¹. The carbon balance declined with a decrease in feed rate and an increase in temperature. This phenomenon became obvious when the reactant flow rate was low. The carbon balance sharply decreased from 90.2% at 700° C. to 63.4% at 800° C., when the GHSV was lowered to 1200/h. Without wishing to be bound by a particular theory, it is believed that this was largely due to the coking caused by the formation of polycyclic aromatics. The data herein demonstrate ethylene can form BTX at low flow rate.

Results and Discussion of Example 5: Oxidative Dehydrogenation of Ethane (ODH). CO₂ has the appropriate oxidative ability and chemical inertness under ambient conditions, and can be used as a mild oxidant for oxidative dehydrogenation of ethane. Distinct from O₂, when CO₂ is used in ODH it can allow decreasing the reaction temperature, as well as prevent the overoxidation of C₂H₆. Meanwhile, during the ODH process, CO₂ is converted to CO that could be used as a precursor for producing valuable chemicals. Two different flow rates with the same ethane concentration were selected to compare the performance of CO₂ in ODH and EDH processes. In EDH-10: GHSV was set at 2400 h⁻¹ (C₂H₆:N₂=1:1); in ODH-10: GHSV was set at 2400 h⁻¹ (C₂H₆:CO₂:N₂=2:1:1); in EDH-20: GHSV was set at 4800 h⁻¹ (C₂H₆:N₂=1:1); in ODH-20: GHSV was set at 4800 h⁻¹ (C₂H₆:CO₂:N₂=2:1:1). That is, ethane was maintained at a concentration of about 50% in the total gas flow, CO₂ concentration was maintained at about 25% in ODH process inlet gas flow, and N₂ was used as inert gas.

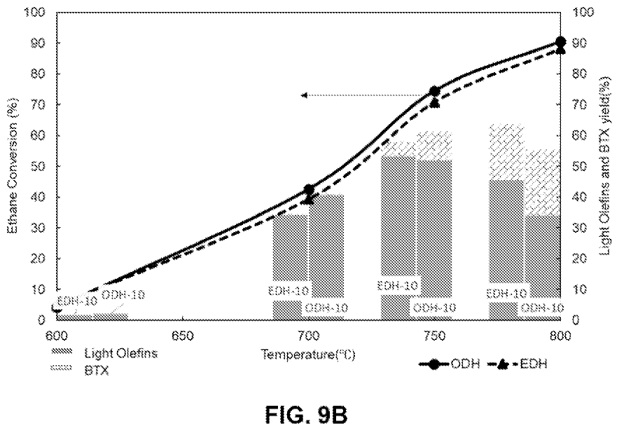

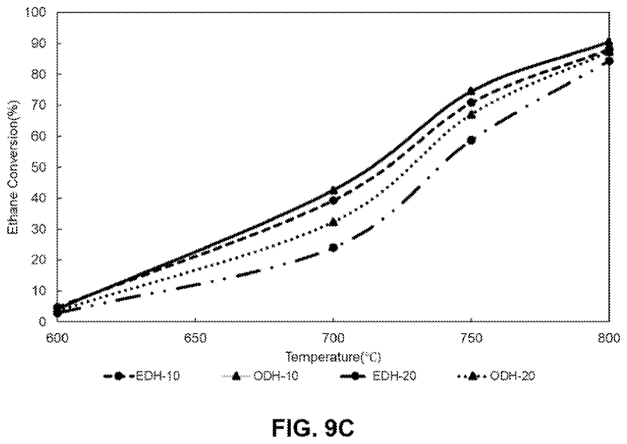

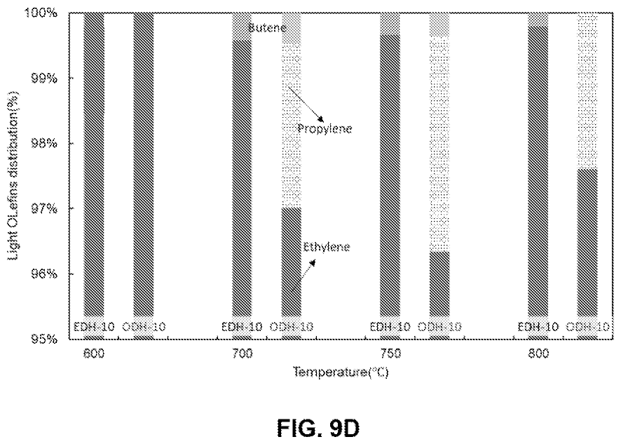

FIGS. 9A-9D show aspects of the ethane ODH performance over Ru/CeO₂ and CsRu/CeO₂. As shown in FIG. 9A, Ru/CeO₂ exhibits much similar ethane conversion as CsRu/CeO₂ in ODH processes. However, the CsRu/CeO₂ catalyst demonstrated a higher yield for the light olefins and BTX. For example, the yields of light olefins over Ru/CeO₂ and CsRu/CeO₂ at 750° C. were 44.4% and 45.8%, respectively, meanwhile, the yields of BTX were 0.9% and 2.1%, respectively. At 800° C., the yield of BTX over a disclosed CsRu/CeO₂ catalyst reached 12.2%. In contrast, at 800° C., the yield of BTX over a disclosed Ru/CeO₂ catalyst was around 8.1%. Furthermore, there was only ethylene and slight C₄ olefin presented in the products over Ru/CeO₂, but both C₃ and C₄ olefin products were detected over CsRu/CeO₂.

The catalytic performance comparison between ethane ODH and EDH over CsRu/CeO₂ catalyst is shown in FIGS. 9B, 3C and 3D. FIG. 9B shows the comparison of ethane conversion and light olefins yield between EDH and ODH processes. At a lower reaction temperature (600-700° C.), the main products were light olefins in both processes, but the light olefins yield was significantly higher in ODH process. At higher reaction temperature (700-800° C.), the BTX was formed and ODH process exhibited higher BTX yield but lower light olefin yield than the EDH process. As shown in FIG. 9B, at 750° C., the yields of light olefins are 53.2% and 52% in EDH and ODH processes, respectively. In contrast, at the same temperature, the BTX yields were 4.8% and 9.3% in EDH and ODH processes, respectively. The BTX yield was increased with an increase in reaction temperature in both EDH and ODH processes. FIG. 9C shows ethane conversion is significantly affected by the gas flow rate at constant CO₂ concentration. Ethane conversion was decreased with an increase in gas mixture flow rate at all reaction temperatures in both the EDH and ODH processes. Without wishing to be bound by a particular theory, it is believed that this may be due to the reduction in contact time between reactant and catalyst. For endothermic ethane dehydrogenation, ethane conversion is believed to be increased with increases in reaction temperature. Comparing ethane conversion between the EDH and ODH processes, it was clear that ethane conversion in the ODH process was higher than that in the EDH process (ODH-10>EDH-10, ODH-20>EDH-20).

In ethane ODH reaction over a disclosed CsRu/CeO₂ catalyst, C₃ and C₄ olefins were produced along with ethylene. FIG. 9D shows the distribution of light olefins in both EDH and ODH processes when the ethane flow rate was set at 10 ml/min using CsRu/CeO₂ as the disclosed catalyst. There were more different kinds of olefins that were generated from the ODH process than from the EDH process. In ODH, the selectivity to C₃ olefins reached 2.5% at 700° C. and continued to increase to 3.8% at 750° C. The selectivity to C₃ and C₄ olefins was decreased at 800° C. Without wishing to be bound by a particular theory, it is believed that this may be due to the aromatization at the higher reaction temperature.

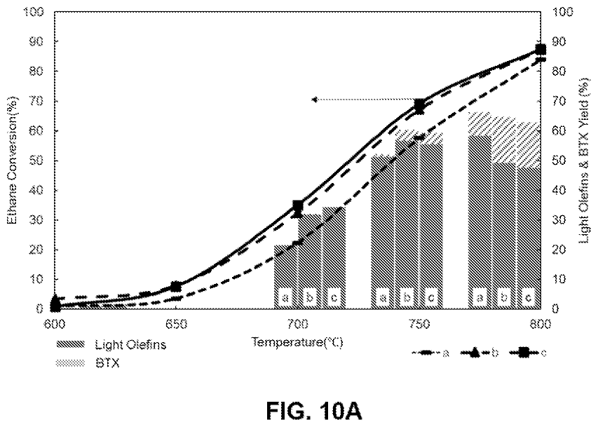

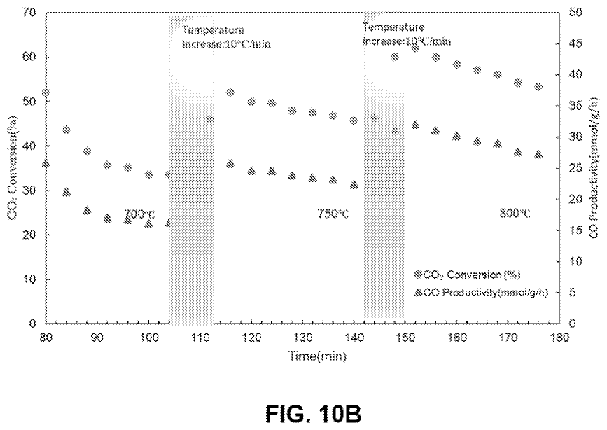

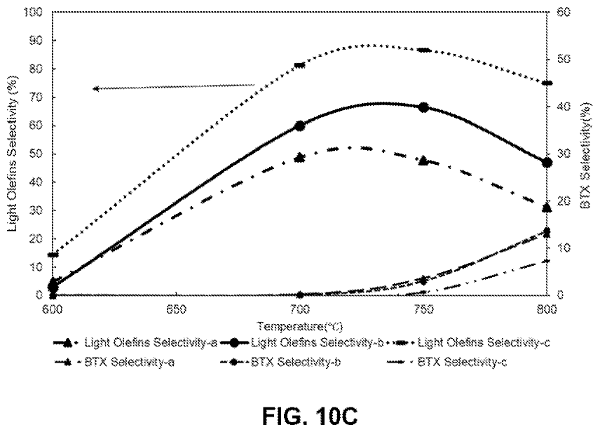

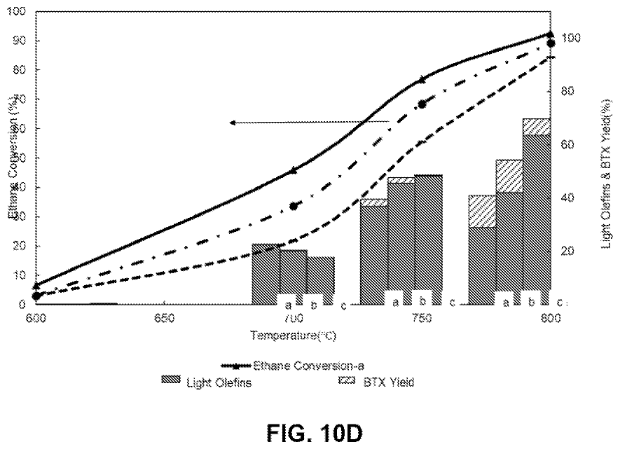

In ODH process, the ratio of CO₂/O₂H₆ could significantly affect the reaction conversion and product distribution. Three different CO₂/O₂H₆ ratios with the same ethane concentration were selected to test over a disclosed CsRu/CeO₂ catalyst. N₂ was used as a balance inert to keep the total flow rate constant, GHSV was set at 4800 h⁻¹. a: CO₂ flow rate was set at 5 ml/min, C₂H₆ flow rate was set at 20 ml/min, N₂ flow rate was set at 15 ml/min; b. CO₂ flow rate was set at 10 ml/min, C₂H₆ flow rate was set at 20 ml/min, N₂ flow rate was set at 10 ml/min; c. CO₂ flow rate was set at 15 ml/min, C₂H₆ flow rate was set at 20 ml/min, N₂ flow rate was set at 5 ml/min. Ethane conversion, light olefins yield and BTX yield are illustrated in FIG. 10A. The data show that ethane conversion was increased with an increase in CO₂ concentration. Without wishing to be bound by a particular theory, it is believed that this may be due to the CO₂ reaction with hydrogen produced from ethane dehydrogenation through reverse water-gas reaction. By removing the hydrogen from the products, the equilibrium of ethane dehydrogenation shifted to the right. The light olefins yield at low temperature (<700° C.) was increased with an increase in CO₂ concentration in the feed stream. However, when the temperature was higher than 700° C., light olefin yield was decreased with an increase in CO₂ concentration due to the formation of aromatics. These results confirm that the presence of CO₂ can lower the ethane dehydrogenation temperature.

To further confirm the role of CO₂ in ethane ODH reaction, time-on-stream CO₂ conversion and CO productivity at different temperatures was studied (FIG. 10B). The CO₂ conversion was increased with an increase in reaction temperature. However, under the same reaction temperature, the CO₂ conversion decreased over the course of reaction. Simultaneously, the CO productivity exhibited the same trend as CO₂ conversion. At 700° C., it decreased from 52.1% to 32.8% after 30 min time-on-stream, meanwhile, the CO productivity decreased from 36.2 mmol/g/h to 22.3 mmol/g/h. This result could be ascribed to the reversible transformation of Ce³⁺/Ce⁴⁺ and the presence of abundant oxygen vacancies. Oxygen vacancies in CeO₂ play an important role in the adsorption and activation of surface adsorbed CO₂. The concentration of oxygen vacancies in CeO₂ supports are highly correlated with the activity of the catalyst, a higher concentration of oxygen vacancies could result in enhanced activity^{[26]}. As the catalyst was reduced by hydrogen from ethane dehydrogenation when temperature was increased, more Ce³⁺ species were formed. This led to the formation of more oxygen vacancies, facilitating CO₂ conversion. When temperature was held steady, the reduction was stabilized, and without wishing to be bound by a particular theory, it is believed that this may be due to no more oxygen vacancies being formed. Meanwhile, more and more Ce³⁺ species were oxidized to Ce⁴⁺, therefore CO₂ conversion decreased.

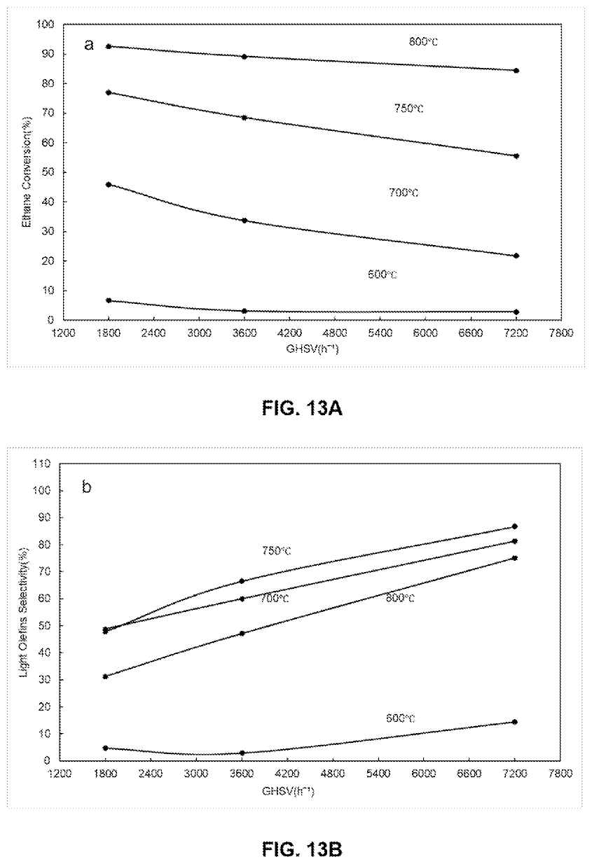

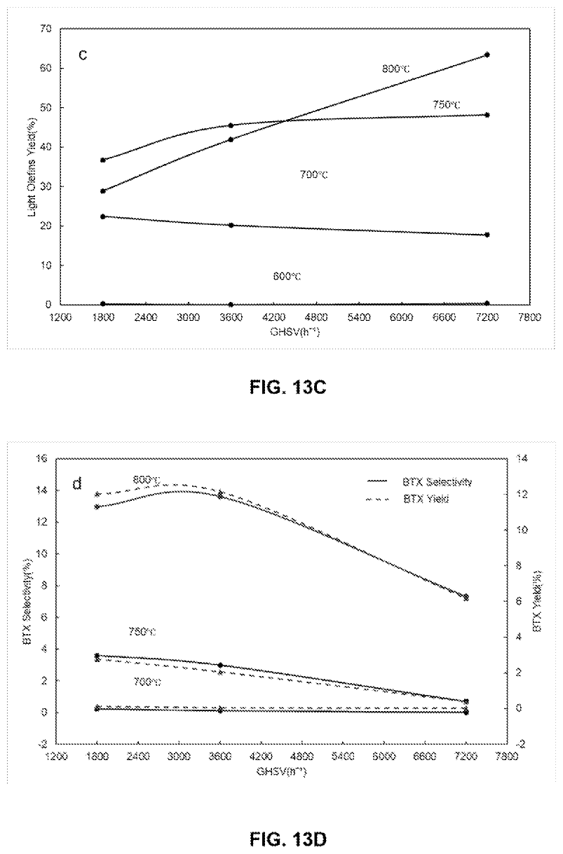

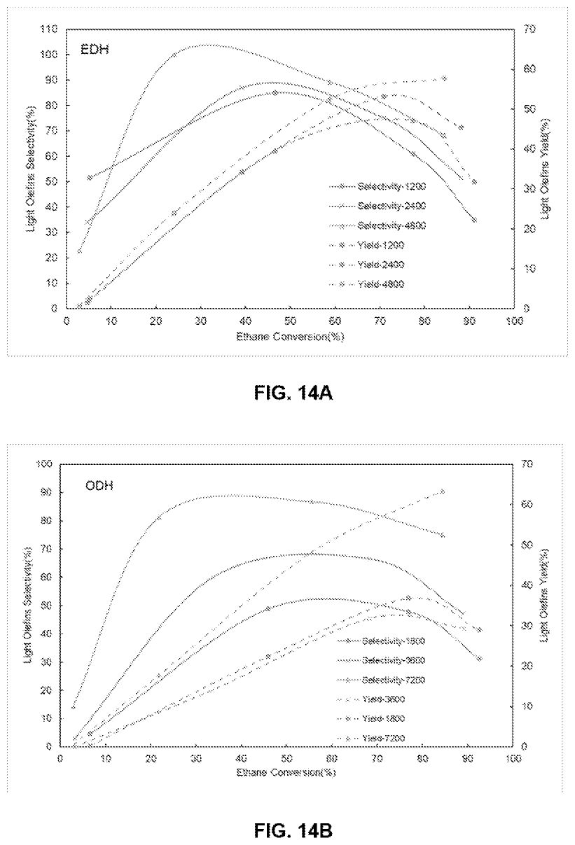

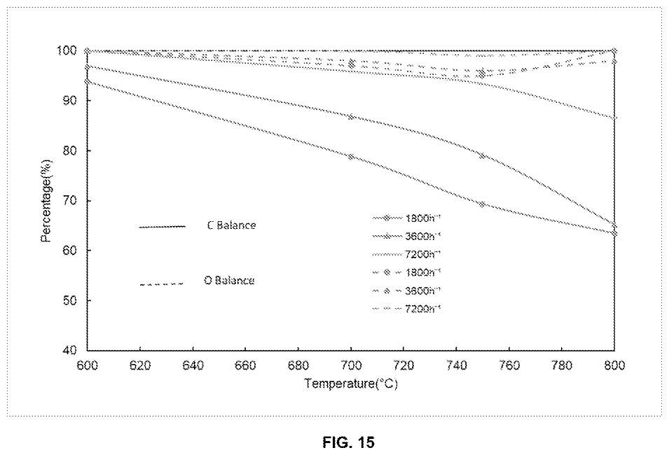

The effect of GHSV over CsRu/CeO₂ was investigated to optimize this ODH process (FIG. 13). Three different GHSV with the same ethane concentration were selected for the test: a. 1800 h⁻¹; b. 3600 h⁻¹; c. 7200 h⁻¹. The ratio of N₂, O₂H₆ and CO₂ is 1:1:1. As shown in FIG. 100 and FIG. 13B, the selectivity to light olefins is increased with an increase in flow rate. It reached the highest 86.7%, at 750° C. under reaction conditions c. By contrast, as shown in FIG. 13D, the selectivity of BTX was decreased with the increase in flow rate which was also observed in the non-oxidative EDH process (FIG. 8). However, as shown in FIG. 10D and FIG. 13A, ethane conversion is decreased with an increase in flow rate. At 750° C., ethane conversion reached 77% with the lowest flow rate, and 55.6% with the highest flow rate. Similar to the EDH process, at low reaction temperatures (<700° C.), the yield of light olefins was decreased with increase in flow rate. In contrast, at higher reaction temperature (>700° C.), the yield of light olefins was increased and the yield of BTX was decreased as the flow rate increased. At 800° C., the yield of BTX reached the highest 12% under condition a, but only 6.2% under condition c. Meanwhile, the yield of light olefins at 800° C. was increased from 28.9% under condition a to 63.4% under condition c (FIG. 10D), which was equivalent to the increase in productivity from 1.55 mmol·g_{cat}⁻¹·h⁻¹ to 33.99 mmol·g_{cat}⁻¹·h⁻¹ when GHSV was changed from 1800 h⁻¹, 7200 h⁻¹. Without wishing to be bound by a particular theory, it is believed that this may be due to the decrease in contact time that restrained the aromatization reaction. In the light olefins products, besides ethylene, only a small amount of butene was detected when flow rate was increased. The carbon and oxygen balances with different reaction temperature and space velocity are also studied. As shown in FIG. 15A, the carbon balance was decreased with increase in reaction temperature and decrease in GHSV. The BTX formation is improved by increase in reaction temperature and decrease in GHSV, however, this facilitates the coke formation due to polymerization of BTX. As shown in FIG. 15B, the oxygen balance for the ODH process is stable, it is close to 100% all the time, the missing part should be attributed to H₂O.

In summary, the performance of disclosed Ru/CeO₂ and CsRu/CeO₂ catalysts in ODH process was compared in EDH process. CsRu/CeO₂ exhibited higher catalytic property of light olefins and BTX than Ru/CeO₂ Results indicated that the addition of CO₂ improved the ethane conversion to ethylene as well as the formation of C₃ and C₄ olefins. In ODH, the effect of feed rate on process performance was similar to that observed in EDH process, the higher feed rate resulted in higher light olefin yield, lower BTX yield and carbon deposition. CO₂ conversion in ODH process over CsRu/CeO₂ was influenced by the temperature. When the reaction temperature was increased, the CO₂ conversion was increased. However, CO₂ conversion tended to decrease as the reaction proceeded over time due to the change of oxidation state of Ce from Ce³⁺ to Ce⁴⁺.

Results and Discussion of Example 5: Stability of Disclosed Catalysts. Although the disclosed CsRu/CeO₂ catalyst showed desirable ethane conversion and light olefins yield, from an industrial standpoint of view, it was believed important to determine the lifetime of the disclosed catalysts. Side reactions associated in ethane catalytic dehydrogenation at high temperature may exist, and they may cause detrimental effect on ethane conversion/selectivity. This may be particularly true when ethane cracking and aromatization reaction occurred with the catalyst deactivating quickly. In general, without wishing to be bound by a particular theory, it is believed that a rapid decrease in activity can be attributed to accumulation of carbon on the catalyst or metal sintering. Besides cerium oxide catalysts, it has been previously reported that other metal oxide catalyst such as Mo₂C can show continued decrease in ethane conversion over time (S. Yao, B. Yan, Z. Jiang, Z. Liu, Q. Wu, J. H. Lee, J. G. Chen, Combining CO2 Reduction with Ethane Oxidative Dehydrogenation by Oxygen-Modification of Molybdenum Carbide, ACS Catal. 2018, 8, 5374-5381). This requires an intermediate high temperature hydrogenation or calcination step for catalyst regeneration.

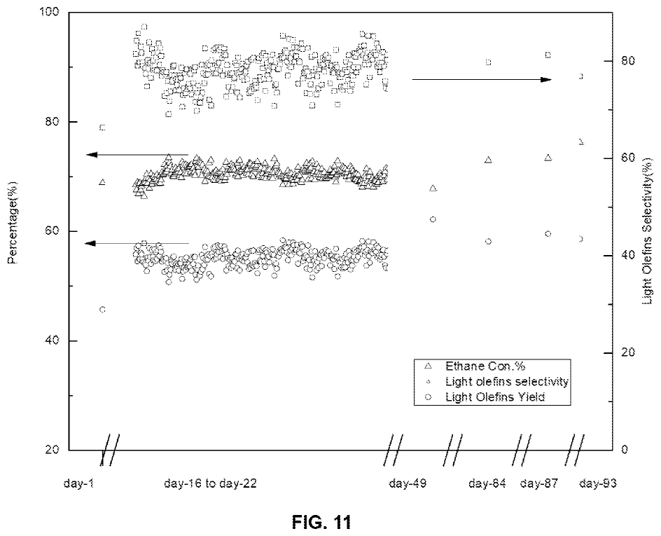

The stability of a disclosed CsRu/CeO₂ was investigated at 750° C., under feed mixture of 10 ml/min of N₂, 10 ml/min of C₂H₆, 10 ml/min of CO₂, the GHSV is 3600 h⁻¹. Time-on-stream ethane conversion, selectivity, and yield of light olefins over a disclosed CsRu/CeO₂ catalyst are illustrated in FIG. 11. The experiment was carried out for a total of 93 days during which there are multiple on-purpose shutdowns and startups. The data were collected continuously between day-16 and day-22. During the other time of this period, the reaction was shut down and re-started every day at different reaction temperatures (400° C.-800° C.) and feed rate (10 ml/min-60 ml/min) to test the stability of CsRu/CeO₂. As shown in FIG. 11, ethane conversion reaches 70% with 78% selectivity to light olefins, resulting in a 55% yield of light olefins. Moreover, the disclosed CsRu/CeO₂ catalyst was kept at a steady state for over 93 days with no loss in ethane conversion and light olefin production.

In summary, the disclosed CsRu/CeO₂ catalyst exhibited excellent stability in ethane conversion, light olefin selectivity and yield. This could be attributed to the redox cycle of Ce species. In the oxidation cycle, Ce³⁺ had a strong tendency to react with CO₂ to form Ce⁴⁺, causing C═O bond scission. Then in the reduction cycle, Ce⁴⁺ was reduced by hydrogen produced from ethane dehydrogenation to form Ce³⁺. The sustained activity can be attributed to the repeated redox cycle. Without wishing to be bound by a particular theory, the Cs may work as a promoter to improve the Ru dispersion and reduce the metal sintering. Furthermore, the data herein show that the disclosed CsRu/CeO₂ catalyst exhibited resistance to carbon deposition, evidenced from the carbon balance measured.

6. Prospective Studies—Further Catalyst Compositions.

Additional disclosed multifunctional catalysts are prepared as described herein above. The additional catalysts will have high activity for ethane and CO₂ conversion with high dielectric response for microwave energy adsorbing. The additional catalysts will comprise other reducible oxides as supports such as one or more of CeO₂, Cr₂O₃, La₂O₃, and Y₂O₃, including these supports at varying particle sizes Moreover, various active metals with high dehydrogenation activity will be utilized in the additional catalysts that are prepared with different active metals, e.g., Ga, Ru, Pt, Pd, Cr, Mn, Fe, Co, Ni, Zn, and combinations thereof. Other parameters systematically explored in the additional catalysts will be catalytic parameters such as surface area, porosity, active metal particle size, dielectric property, chemical and electronic oxidation state. The additional catalyst studies will compare catalysts with no promoter versus the same catalyst prepared using one or more promoter, e.g., Li, Na, K, Mg, Ca, Ba, Cs, or combinations thereof. Each of these, i.e., active metals and promoters will be examined at varying metal and promoter loading (wt %) with the support. The scope of the parameters that can be explored in these prospective studies are as described in the claims that are a part of the present disclosure.

7. Prospective Studies—Further Assessment of Process Conditions.

The microwave frequency will be systematically explored to determine a range of suitable microwave frequencies for use with the disclosed processes, e.g., effects of microwave frequency, input power, and surface temperature of catalyst on the ethane and CO₂ conversion, H₂ formation rate and products selectivity will be investigated. Specifically, the activity of each catalyst developed as described above will be correlated to microwave energy frequency and power along with the ethane conversion and H₂ production.

A further aspect explored in these prospective studies is the reaction mixture gas, e.g., different ethane/CO₂ molar ratio will be tested in microwave reactor to determine the effect of CO₂ concentration on the process performance. Moreover, natural gas contains methane, ethane, propane and butanes. A model mixture of the feedstock will be tested in microwave reactor to determine the effect of different carbon chain length on the process performance.

8. Prospective Studies—Further Examination of Catalyst Stability.

The data described above show that an exemplary multifunctional CsRu/CeO₂ catalyst demonstrated more than 10 h stability under thermal heating condition. The long-term stability and duration of the catalysts are important to low cost H₂ production. The stability of the selected catalysts from the prospective studies described above will be further tested under microwave energy conditions with variation in power and frequency as well as reactor orientation in the microwave energy field (E-Field vs H-Field orientation). A more than 100 h life-time testing will be carried out under microwave energy conditions including 10 or more times shut-down/star-up. As required, adjustments to the catalyst formulation will be made to improve the catalyst stability.

9. Prospective Studies—Further Catalyst Characterization.

These effects and relation of electronic and geometric structures of active metal, in the presence and absence of one or more promoter, to the catalytic activity will be systematically investigated. The effect of the promoters and support on the surface morphology of active metal will be studied by advanced microscopy (e.g., TEM, SEM, XPS, Raman, In situ FT-IR). Moreover, the particle structure and metal dispersion on the catalysts will be measured by CO-chemisorption. The internal structure and porous texture of the catalysts will be examined by TEM and BET. In order to learn more about the structure and electron promotion effects of the promoters and support, XPS will be employed to measure the surface composition and oxidation states of catalyst. The XPS studies will also reveal the changes of catalyst support chemical state. The sensitivity (dielectric loss) in response to the microwave energy irradiation will be measured by the Dielectric Analyzer. In addition, characterizations such as TPO and TPR can also be used to characterize these catalysts in order to understand the mechanism of the catalytic and promotion effects.

10. Prospective Studies—Kinetic Modeling.

These prospective studies are directed to determining a detailed rate law for the CO₂-DHA reaction in the microwave energy reactor and an enhanced understanding of which primary rate constants are affected by the microwave. The data obtain can be useful in selecting which types of active sites will exhibit efficient interaction with ethane and CO₂. In these studies, the power threshold at which products begin to appear will be determined. Once the threshold is established, a systematic study of the temperature of the catalyst can be done by changing the applied power and carrying out kinetic analysis of products generated over a range of fixed temperatures. A full kinetic study can involve changing the gas hourly space velocity (GHSV), catalyst temperature, and CO₂/ethane concentrations. Experimental data will be fitted to a complex rate law where elementary rate constants for the reaction can be determined. Establishing a primary rate equation can be useful to optimize H₂ production.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A multifunctional catalyst comprising:
a catalyst support comprising CeO₂, Cr₂O₃, La₂O₃, Y₂O₃, or combinations thereof;
a catalyst metal comprising at least one metal selected from Groups 6-11; and
optionally a catalyst promoter comprising at least one metal selected from Group 1, and Group 2;
wherein the catalyst is capable of interacting with microwave energy in the frequency range of 300 MHz to 50 GHz;
wherein the catalyst metal is present in an amount from about 0.1 wt % to about 20 wt %;
wherein the catalyst promoter, when present, is in an amount from about 0.1 wt % to about 20 wt %; and
wherein the wt % is based on the total weight of the catalyst support, the catalyst metal, and the catalyst promoter, when present.

2. The multifunctional catalyst of claim 1, wherein the catalyst metal is selected from Ga, Ru, Pt, Pd, Cr, Mn, Fe, Co, Ni, Zn, and combinations thereof.

3. The multifunctional catalyst of claim 2, wherein the catalyst metal is selected from Ru, Pt, Ni, and combinations thereof.

4. The multifunctional catalyst of claim 3, wherein the catalyst metal is Ru.

5. The multifunctional catalyst of claim 1, wherein the single catalyst metal is selected from Pt, Ga, Ru, and Ni.

6. The multifunctional catalyst of claim 1, wherein the catalyst metal comprises two catalyst metals selected from Groups 6-11.

7. The multifunctional catalyst of claim 6, wherein the two catalyst metals comprise Ru and Fe; or wherein the two catalyst metals comprise Ru and Pd.

8. The multifunctional catalyst of claim 1, wherein the catalyst metal is present in an amount from about 0.5 wt % to about 18 wt %.

9. The multifunctional catalyst of claim 8, wherein the catalyst metal is present in an amount from about 0.5 wt % to about 6 wt %.

10. The multifunctional catalyst claim 1, wherein the catalyst promoter is Li, Na, K, Mg, Ca, Ba, Cs, or combination thereof.

11. The multifunctional catalyst of claim 1, wherein the catalyst promoter is present in an amount from about 2 wt % to about 6 wt %.

12. The multifunctional catalyst of claim 1, wherein the total wt % of both the catalyst metal and the catalyst promoter is from about 3 wt % to about 10 wt %.

13. The multifunctional catalyst of claim 1, wherein the multifunctional catalyst has a particle size from about 10 nm to about 50 μm.

14. The multifunctional catalyst of claim 1, wherein catalyst support comprises CeO₂, La₂O₃, or combinations thereof.

15. The multifunctional catalyst of claim 14, wherein catalyst support comprises CeO₂ and La₂O₃; and wherein the CeO₂ and La₂O₃ are present in a 1:1 ratio based on weight.

16. The multifunctional catalyst of claim 1, wherein catalyst support has a particle size from about 1 nm to about 50 μm.

17. The multifunctional catalyst claim 1, wherein the catalyst the catalyst metal has a particle size of from about 0.1 nm to about 1 μm.

18. A process for carbon-dioxide assisted dehydroaromatization, the process comprising:
providing a reaction chamber within a reactor with a multifunctional catalyst of claim 1,
heating the multifunctional catalyst using microwave energy with microwave energy in the frequency range of 300 MHz to 50 GHz;
conveying a flow of a reactant gas mixtures into the reaction chamber via an entry port;
wherein the reaction chamber pressurizes the reaction chamber to a pressure from about 0.9 atm to about 70 atm;
contacting the reactant mixture with the multifunctional catalyst; and
reacting the reactant gas mixture in contact with the heterogenous catalyst, thereby providing a product mixture;
wherein the multifunctional catalyst has a multifunctional catalyst temperature of from about 100° C. to about 800° C.;
wherein the reactant mixture comprises a hydrocarbon and optionally carbon dioxide; and
wherein the product mixture comprises hydrogen and at least one aromatic or alkene.

19. The process of claim 18, wherein the hydrocarbon is a hydrocarbon gas, a plastic, a biomass product, or combinations thereof.

20. The process of claim 19, wherein the hydrocarbon gas comprises a C2 hydrocarbon, a C3-C5 alkane, a C6 aromatic, or combinations thereof.

21. The process of claim 19, further comprising hydrogen.

22. The process of claim 19, wherein the plastic is a polyethylene, polypropylene, and combinations thereof.

23. The process of claim 18, wherein the reactant mixture is pre-heated to a reactant mixture pre-heat temperature prior to conveying the flow of carbon dioxide into the reaction chamber via an entry port; and wherein the reactant mixture pre-heat temperature is from wherein the reactant mixture pre-heat temperature is from about 250° C. to about 450° C.

24. The process of claim 18, wherein the reaction chamber pressurizes the reaction chamber to a pressure from about 0.9 atm to about 60 atm.

25. The process of claim 189, where the reaction chamber pressurizes the reaction chamber to a pressure from about 1 atm to about 60 atm.

26. The process of claim 150, wherein the multifunctional catalyst temperature is from wherein 550° C. to about 650° C.

27. The process of claim 18, wherein the product mixture comprises hydrogen and one or more of ethylene, acetylene, propylene, butene, butadiene, benzene, toluene, or xylene.

28. The process of any one of claim 27, the product mixture has benzene selectivity from about 10 wt % to about 50 wt %.
